(19) United States
(12) Patent Application Publication
(10) Pub. No.: US 2023/0294517 A1
(43) Pub. Date: Sep. 21, 2023

(54) VEHICLE DISPLAY CONTROL DEVICE, DISPLAY DEVICE, AND VEHICLE DISPLAY CONTROL METHOD

(71) Applicant: Panasonic Intellectual Property Management Co., Ltd., Osaka (JP)

(72) Inventors: Yoshiki ITO, OSAKA FU (JP); Kazuomi KATO, KYOTO FU (JP); Isao NOGUCHI, NARA KEN (JP); Nobutoshi HIGAKI, KYOTO FU (JP); Tetsuji YAMAMOTO, OSAKA FU (JP); Kenya MATSUSHITA, KYOTO FU (JP); Tomonori UEMURA, KYOTO FU (JP)

(73) Assignee: Panasonic Intellectual Property Management Co., Ltd., Osaka (JP)

(21) Appl. No.: 18/101,821

(22) Filed: Jan. 26, 2023

(30) Foreign Application Priority Data
Mar. 17, 2022 (JP) 2022-042521

(51) Int. Cl. B60K 35/00

(52) U.S. Cl. CPC B60K 35/00; B60K 2370/166; B60K 2370/168; B60K 2370/178; B60K 2370/1868; B60K 2370/1876; B60K 2370/52

(57) ABSTRACT

A vehicle display control device provided in a vehicle is disclosed. The apparatus includes processing circuitry. The processing circuitry recognizes a traffic regulation mark indicating a traffic regulation provided on a traveling route of the vehicle. The processing circuitry controls a display device to display first content information and second content information in a display area in front of a driver's seat of the vehicle. The first content information indicates content of a regulation in an effective range indicated by the traffic regulation mark in a case where the vehicle enters the effective range of the regulation. The second content information indicates content other than the first content information. The processing circuitry controls display of the first content information and the second content information in the display area on the basis of priorities set for the first content information and the second content information.

### CROSS-REFERENCE TO RELATED APPLICATIONS

This application is based upon and claims the benefit of priority from Japanese Patent Application No. 2022-042521, filed on Mar. 17, 2022, the entire contents of which are incorporated herein by reference.

### FIELD

The present disclosure relates generally to a vehicle display control device, a display device, and a vehicle display control method.

### BACKGROUND

Conventionally, there has been known a vehicle display control device that displays content of a regulation indicated by a traffic regulation mark (for example, JP 2020-47289). In such a vehicle display control device, when a vehicle with this apparatus enters an effective range of regulation indicated by a traffic regulation mark, remaining amount information indicating a remaining amount specified by a remaining amount specifying unit is displayed in a display area in addition to regulation content information indicating content of the regulation in the effective range. In addition, the display area in which remaining amount information is displayed is switched in accordance with a situation of the vehicle with respect to the effective range.

However, in a case where a plurality of pieces of information is displayed, such as a case where information other than the content of the regulation indicated by the traffic regulation mark is displayed, there is a possibility that appropriate display cannot be performed.

### SUMMARY

A vehicle display control device according to the present disclosure is provided in a vehicle. The vehicle display control device includes processing circuitry connected to a memory. The processing circuitry is configured to recognize a traffic regulation mark indicating a traffic regulation provided on a traveling route of the vehicle. The processing circuitry is configured to control a display device to display first content information and second content information in a display area in front of a driver's seat of the vehicle. The first content information indicates content of a regulation in an effective range indicated by the traffic regulation mark in a case where the vehicle enters the effective range of the regulation. The second content information indicates content other than the first content information. The processing circuitry is configured to control display of the first content information and the second content information in the display area on the basis of priorities set for the first content information and the second content information.

A vehicle display control method according to the present disclosure is a method for controlling a display device provided in a vehicle. The vehicle display control method includes recognizing a traffic regulation mark indicating a traffic regulation provided on a traveling route of the vehicle. The vehicle display control method includes controlling the display device to display first content information and second content information in a display area in front of a driver's seat of the vehicle. The first content information indicates content of a regulation in an effective range indicated by the traffic regulation mark in a case where the vehicle enters the effective range of the regulation. The second content information indicates content other than the first content information. The vehicle display control method includes controlling display of the first content information and the second content information in the display area on the basis of priorities set for the first content information and the second content information.

### BRIEF DESCRIPTION OF THE DRAWINGS

FIG. 1 is a diagram illustrating an example of a configuration of a vehicle system according to an embodiment;

FIG. 2 is a block diagram illustrating an example of a functional configuration of a vehicle display control device according to the embodiment;

FIG. 3 is a flowchart illustrating an example of regulation display control-related processing of the vehicle display control device according to the embodiment;

FIG. 4 is a schematic diagram illustrating an example of a situation of a host vehicle with respect to a regulation effective range;

FIG. 5 is a diagram illustrating an example of display of first content information and remaining amount information in a proximal display area and a distal display area at a vehicle position P1 in FIG. 4;

FIG. 6 is a diagram illustrating another example of display of the first content information and the remaining amount information in the proximal display area and the distal display area at the vehicle position P1 in FIG. 4;

FIG. 7 is a diagram illustrating an example of display of first content information and remaining amount information in a proximal display area and a distal display area at a vehicle position P2 in FIG. 4;

FIG. 8 is a diagram illustrating an example of display of first content information and remaining amount information in a proximal display area and a distal display area at a vehicle position P3 in FIG. 4;

FIG. 9 is a schematic diagram illustrating another example of a situation of the host vehicle with respect to a regulation effective range;

FIG. 10 is a diagram illustrating an example of display of first content information and remaining amount information in a proximal display area and a distal display area at a vehicle position P11 in FIG. 9;

FIG. 11 is a diagram illustrating an example of display of first content information and remaining amount information in a proximal display area and a distal display area at a vehicle position P12 in FIG. 9;

FIG. 12 is a diagram illustrating an example of display of first content information and remaining amount information in a proximal display area and a distal display area at a vehicle position P13 in FIG. 9;

FIG. 13 is a diagram illustrating an example of display of first content information and remaining amount information in a proximal display area and a distal display area at a vehicle position P14 in FIG. 9;

FIG. 14 is a diagram illustrating an example of display of first content information and remaining amount information in a proximal display area and a distal display area at a vehicle position P15 in FIG. 9;

FIG. 15 is a diagram illustrating an example of display of first content information and remaining amount information in a proximal display area and a distal display area at a vehicle position P16 in FIG. 9;

FIG. 16 is a diagram illustrating an example of display of first content information and remaining amount information in a proximal display area and a distal display area at a vehicle position P17 in FIG. 9;

FIG. 17 is a diagram illustrating another example of display of the first content information and the remaining amount information in the proximal display area and the distal display area at the vehicle position P14 in FIG. 9;

FIG. 18 is a diagram illustrating another example of display of the first content information and the remaining amount information in the proximal display area and the distal display area at the vehicle position P14 in FIG. 9;

FIG. 19 is a diagram illustrating another example of display of the first content information and the remaining amount information in the proximal display area and the distal display area according to a traveling situation of the host vehicle;

FIG. 20 is a schematic diagram illustrating information stored in a nonvolatile memory of the vehicle display control device according to the embodiment;

FIG. 21 is a schematic diagram illustrating another example of a situation of the host vehicle with respect to a regulation effective range;

FIG. 22 is a diagram illustrating an example of display of first content information, remaining amount information, and second content information in a proximal display area and a distal display area at a vehicle position P21 in FIG. 21;

FIG. 23 is a diagram illustrating an example of display of first content information, remaining amount information, and second content information in a proximal display area and a distal display area at a vehicle position P22 in FIG. 21;

FIG. 24 is a diagram illustrating another example of display of the first content information, the remaining amount information, and the second content information in the proximal display area and the distal display area at the vehicle position P21 in FIG. 21;

FIG. 25 is a diagram illustrating another example of display of the first content information, the remaining amount information, and the second content information in the proximal display area and the distal display area at the vehicle position P22 in FIG. 21;

FIG. 26 is a schematic diagram illustrating another example of a situation of the host vehicle with respect to a regulation effective range;

FIG. 27 is a diagram illustrating an example of display of first content information, remaining amount information, and second content information in a proximal display area and a distal display area at a vehicle position P31 in FIG. 26;

FIG. 28 is a diagram illustrating another example of display of the first content information, the remaining amount information, and the second content information in the proximal display area and the distal display area at the vehicle position P31 in FIG. 26;

FIG. 29 is a schematic diagram illustrating another example of a situation of the host vehicle with respect to a regulation effective range;

FIG. 30 is a diagram illustrating an example of display of first content information, remaining amount information, and second content information in a proximal display area and a distal display area at a vehicle position P41 in FIG. 29;

FIG. 31 is a diagram illustrating another example of display of the first content information, the remaining amount information, and the second content information in the proximal display area and the distal display area at the vehicle position P41 in FIG. 29; and

FIG. 32 is a hardware configuration diagram illustrating an example of the vehicle display control device according to the embodiment.

### DETAILED DESCRIPTION

Hereinafter, embodiments of the present disclosure will be described in detail with reference to the drawings as appropriate. However, unnecessary detailed description may be omitted. For example, a detailed description of a well-known matter and a repeated description of substantially the same configuration may be omitted. This is to avoid unnecessary redundancy of the following description and to facilitate understanding of those skilled in the art.

Note that the accompanying drawings and the following description are provided for those skilled in the art to fully understand the present disclosure, and are not intended to limit the subject matter described in the claims.

### Embodiment

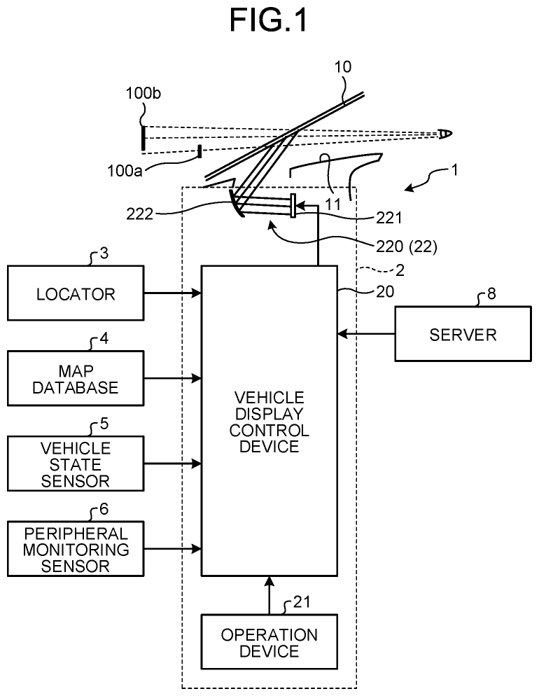

An embodiment will be described below with reference to FIGS. 1 to 31.

Schematic Configuration of Vehicle System 1

First, a configuration of the vehicle system 1 according to the present embodiment will be described with reference to FIG. 1. FIG. 1 is a diagram illustrating an example of a configuration of a vehicle system 1 according to an embodiment.

The vehicle system 1 is used in a vehicle such as an automobile, and includes a human machine interface (HMI) system 2, a locator 3, a map database 4, a vehicle state sensor 5, a peripheral monitoring sensor 6, and a server 8. It is assumed that the HMI system 2, the locator 3, the map database 4, the vehicle state sensor 5, the peripheral monitoring sensor 6, and the server 8 are connected to, for example, an in-vehicle local area network (LAN). Hereinafter, a vehicle using the vehicle system 1 is referred to as a host vehicle.

The locator 3 includes a global navigation satellite system (GNSS) receiver (not illustrated) and an inertial sensor (not illustrated). The GNSS receiver receives positioning signals from a plurality of artificial satellites. The inertial sensor includes, for example, a three-axis gyro sensor and a three-axis acceleration sensor. The locator 3 sequentially measures a vehicle position of the host vehicle on which the locator 3 is mounted by combining a positioning signal received by the GNSS receiver and a measurement result of the inertial sensor. Note that the locator 3 may measure the vehicle position of the host vehicle using a travel distance obtained from signals sequentially output from a vehicle speed sensor mounted on the host vehicle.

The map database 4 is a nonvolatile memory and stores map data such as link data and node data. The link data includes data such as a link ID for specifying a link, a link length indicating a length of a link, a link orientation, a link travel time, link shape information, node coordinates (latitude/longitude) between a start edge and an end edge of a link, and a road attribute. It is assumed that the data of the road attribute includes, for example, data (hereinafter, referred to as regulation data) about a regulation by a traffic regulation mark which is at least one of a road sign and a road mark. Examples of the regulation include speed limit, no parking, no overtaking, and vehicle no vehicle crossing.

In addition, the traffic regulation mark also includes a sign (auxiliary sign) that supplements the regulation data, and the data of the road attribute also includes data of the auxiliary sign (hereinafter, referred to as auxiliary data). As an example of the auxiliary data, there is data specifying a length or a range of an area to which the regulation is applied (hereinafter, referred to as effective range data). Note that the regulation data and the auxiliary data may be stored in the map database 4 as data other than the link data. The node data includes data such as a node ID to which a unique number is assigned for each node on a map, node coordinates, a node name, a node type, a connection link ID in which a link ID of a link connected to a node is described, and an intersection type.

The vehicle state sensor 5 is a sensor group for detecting the state of the host vehicle. Examples of the vehicle state sensor 5 include a vehicle speed sensor that detects a vehicle speed of the host vehicle. In addition, the state of the host vehicle to be detected by the vehicle state sensor 5 includes the presence or absence and content of an abnormality such as a failure. The vehicle state sensor 5 outputs the detection result to the in-vehicle LAN. Note that the detection result of the vehicle state sensor 5 may be output to the in-vehicle LAN via an electronic control unit (ECU) mounted on the host vehicle.

The peripheral monitoring sensor 6 recognizes a travel environment of the host vehicle. The peripheral monitoring sensor 6 detects an obstacle such as a stationary object or a moving body around the host vehicle, and detects a road mark such as a road sign or a traveling lane. As the peripheral monitoring sensor 6, a front camera having a predetermined range ahead of the host vehicle as an imaging range may be used. For example, the front camera may be provided in a rearview mirror of the host vehicle. Note that the front camera may be provided on the upper surface of an instrument panel 11 of the host vehicle. As the peripheral monitoring sensor 6, a camera that captures an image of a range other than a range ahead of the host vehicle may be used, or a millimeter-wave radar, sonar, light detection and ranging (LiDAR), and the like may be used.

The HMI system 2 includes a vehicle display control device 20, an operation device 21, and a display device 22. The HMI system 2 receives an input operation from the driver of the host vehicle and suggests information to the driver of the host vehicle. The operation device 21 is a group of switches operated by the driver of the host vehicle. The operation device 21 is used to perform various settings. Examples of the operation device 21 include a steering switch provided on a spoke portion of the steering of the host vehicle. Note that the driver is an example of a “user” in Claims.

The display device 22 suggests information to the driver by displaying information in accordance with an instruction from the vehicle display control device 20. Examples of the display device 22 include a head-up display (HUD) 220, a combination meter, a center information display (CID), and the like. The HUD 220 projects light of a display image based on image data acquired from the vehicle display control device 20 onto a projection area in front of the driver's seat of the host vehicle, displaying a virtual image of the display image to be superimposed on part of the foreground in a manner that the driver can visually recognize the virtual image. The combination meter and the CID display information by, for example, a liquid crystal display. The combination meter is disposed on the instrument panel 11 in front of the driver's seat. The CID is disposed above the center cluster.

In the present embodiment, in particular, a case where HUD 220 capable of displaying virtual images of respective display images in a manner that the images are visually recognizable to a driver by projecting the display images onto two projection areas having different positions is used as the display device 22 will be described as an example.

As illustrated in FIG. 1, the HUD 220 is provided on the instrument panel 11 of the host vehicle. The HUD 220 projects a display image formed by, for example, a display 221 of liquid crystal type or scanning type onto a predetermined projection area of a windshield 10 as a projection member a through a projection unit 222 such as a concave mirror. The display 221 displays a plurality of display images in accordance with an instruction from the vehicle display control device 20. The projection unit 222 (an example of an optical system) projects the plurality of display images displayed by the display 221 onto two projection areas having different positions by different optical paths. The light flux of the display image reflected toward the vehicle interior by the windshield is perceived by the driver seated on the driver's seat. In addition, the driver seated on the driver's seat also perceives the light flux from the foreground as a landscape ahead of the host vehicle, the light flux having passed through the windshield 10 made of translucent glass. As a result, the driver can visually recognize virtual images 100a and 100b of the plurality of display images formed in front of windshield 10 while overlapping those images with part of the foreground. That is, the HUD 220 superimposes and displays the virtual images 100a and 100b on the foreground of the host vehicle to realize so-called augmented reality (AR) display. Note that the projection member on which the HUD 220 projects the display image is not limited to the windshield 10, and may be a translucent combiner or the like. In addition, the vehicle display control device 20 may be included in components of the HUD 220.

As illustrated in FIG. 1, the virtual image displayed by the HUD 220 includes a proximal virtual image 100a and a distal virtual image 100b. Each of a range in which the proximal virtual image 100a can be displayed (hereinafter, referred to as a proximal display area) and a range in which the distal virtual image 100b can be displayed (hereinafter, referred to as a distal display area) has a horizontally long rectangular shape in which sides in the vehicle width direction are longer. The size of the distal display area is set to be larger than the size of the proximal display area.

In addition, the proximal virtual image 100a and the distal virtual image 100b are formed at different positions in the front-rear direction of the host vehicle when visually recognized by the driver. The proximal virtual image 100a is formed at a position closer to the windshield 10 than the distal virtual image 100b. Moreover, the proximal virtual image 100a and the distal virtual image 100b are also formed at positions shifted in the up-down direction for visual recognition by the driver. In other words, the proximal virtual image 100a and the distal virtual image 100b are also formed at positions shifted in the vertical direction. Specifically, the imaging position of the proximal virtual image 100a is set to be lower than the imaging position of the distal virtual image 100b. In addition, the image forming position of the distal virtual image 100b is preferably set to be approximately the same height as the eye point of the driver for visual recognition of the driver, for example, as illustrated in FIG. 1.

Note that, for visual recognition of the driver, the lower edge portion of the distal virtual image 100b may be positioned below the upper edge portion of the proximal virtual image 100a. For example, the distal display area may be partially cut-away rectangular to avoid the proximal display area. In addition, the lower side of the distal display area and the upper side of the proximal display area may be separated in the up-down direction.

The vehicle display control device 20 mainly includes a microcomputer including a processor, a computer-readable non-transitory recording medium such as a volatile memory and a nonvolatile memory, an I/O, and a bus that connects these elements. The vehicle display control device 20 is connected to the operation device 21, the display device 22, and the in-vehicle LAN. The vehicle display control device 20 executes various types of processing by executing a control program stored in the nonvolatile memory. For example, the vehicle display control device 20 controls display by the HUD 220. Note that the functional configuration of the vehicle display control device 20 related to the display control by the HUD 220 will be described in detail later.

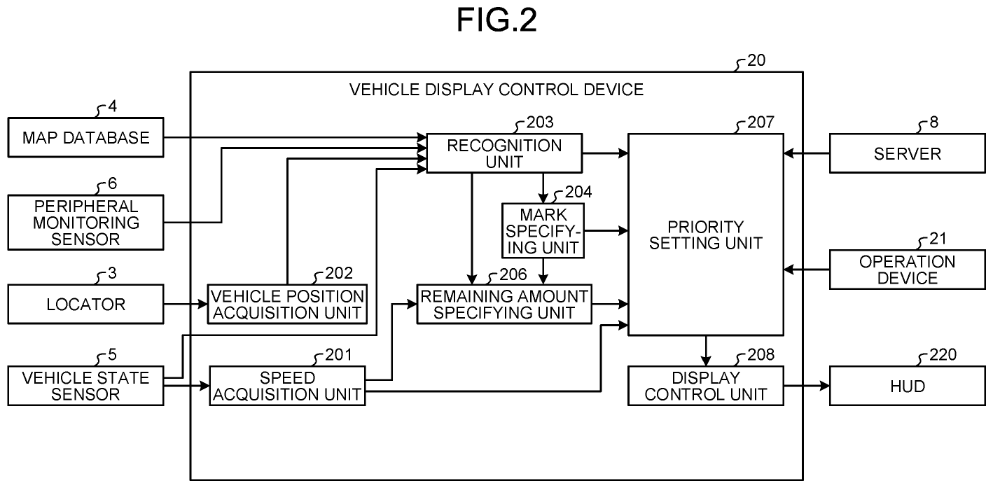

Schematic configuration of vehicle display control device 20 Next, a functional configuration of the vehicle display control device 20 according to the present embodiment will be described with reference to FIG. 2. FIG. 2 is a block diagram illustrating an example of a functional configuration of the vehicle display control device 20 according to the embodiment.

As illustrated in FIG. 2, the vehicle display control device 20 has functions as a speed acquisition unit 201, a vehicle position acquisition unit 202, a recognition unit 203, a mark specifying unit 204, a remaining amount specifying unit 206, a priority setting unit 207, and a display control unit 208 with respect to the display control by the HUD 220. Note that part of or all the functions executed by the vehicle display control device 20 may be configured as hardware by one or a plurality of ICs and the like. Part of or all the functions of the vehicle display control device 20 may be implemented by a combination of execution of software by a processor and a hardware member.

The speed acquisition unit 201 acquires the speed of the host vehicle from the vehicle speed sensor among the vehicle state sensors 5. The vehicle position acquisition unit 202 acquires the vehicle position of the host vehicle measured by the locator 3. The recognition unit 203 recognizes a traffic regulation mark located on the traveling route ahead of the host vehicle. The mark specifying unit 204 specifies an effective range of regulation (hereinafter, referred to as a regulation effective range) indicated by the traffic regulation mark.

The recognition unit 203 determines presence of at least one of the regulation data and the auxiliary data associated with the link of the traveling route ahead of the host vehicle, by using the vehicle position of the host vehicle acquired by the vehicle position acquisition unit 202 and the above-described regulation data and auxiliary data of the map data stored in the map database 4. In a case where at least one of the regulation data and the auxiliary data associated with the link of the front of the traveling route of the host vehicle exists, the recognition unit 203 recognizes the traffic regulation mark indicated by at least one of the regulation data and the auxiliary data as the traffic regulation mark located on the traveling route ahead of the host vehicle.

In addition, the recognition unit 203 recognizes the travel environment of the host vehicle from the detection result of the peripheral monitoring sensor 6. For example, the recognition unit 203 recognizes a traffic regulation mark or recognizes the presence or absence of a preceding vehicle from a captured image (hereinafter, referred to as a front image) acquired from the front camera by image recognition processing such as pattern matching. The recognition of the traffic regulation mark by the recognition unit 203 includes recognition of the content of the auxiliary sign in the traffic regulation mark in addition to the content of the regulation indicated by the traffic regulation mark. The content of the auxiliary sign may be recognized using pattern matching or a character string detection technique. In a case where the recognition unit 203 can recognize the traffic regulation mark from the front image, the recognition unit 203 may recognize the traffic regulation mark as a traffic regulation mark located on the traveling route ahead of the host vehicle.

In addition, the recognition unit 203 recognizes an object positioned around the host vehicle from the detection result of the peripheral monitoring sensor 6. The recognition unit 203 can determine whether the object is a pedestrian, a bicycle, a motorcycle, or a vehicle on the basis of characteristics such as the shape, size, temperature, moving speed, sound, and reflectance of the object. Note that the type of the object is not limited to a pedestrian, a bicycle, a motorcycle, and a vehicle, and the recognition unit 203 may be configured to be able to detect a moving body of a category other than the above, or an object such as a lane, a building, a utility pole, or a fence other than the moving body.

In addition, the recognition unit 203 acquires a route from the current location to the destination from the map database 4. The recognition unit 203 can recognize guidance information for giving a guide to a route to a destination from the vehicle position of the host vehicle acquired by the vehicle position acquisition unit 202 and the map data stored in the map database 4.

In addition, the recognition unit 203 recognizes the occurrence of abnormality of the host vehicle from the detection result of the vehicle state sensor 5. For example, the recognition unit 203 may recognize that an abnormality has occurred in the host vehicle when receiving information indicating the occurrence of the abnormality from the vehicle state sensor 5, or may recognize that an abnormality has occurred in the host vehicle when communication from the vehicle state sensor 5 is disconnected.

In a case where the recognition unit 203 recognizes the traffic regulation mark located on the traveling route ahead of the host vehicle, the mark specifying unit 204 specifies the regulation effective range indicated by the traffic regulation mark. The mark specifying unit 204 may be configured to specify the regulation effective range from the auxiliary data including the above effective range data among the map data stored in the map database 4. Alternatively, the mark specifying unit 204 may be configured to specify the regulation effective range from the content of the auxiliary sign in a case where the content of the auxiliary sign in the traffic regulation mark is recognized by the recognition unit 203 from the front image acquired from the front camera. For example, in a case where the recognition unit 203 recognizes the content of the auxiliary sign such as “100 m hereafter”, the mark specifying unit 204 may specify the regulation effective range as 100 M.

The remaining amount specifying unit 206 specifies a remaining amount (hereinafter, referred to as a start remaining amount) required from the vehicle position of the host vehicle to the start position of the regulation effective range, and specifies a remaining amount (hereinafter, referred to as an end remaining amount) required from the vehicle position of the host vehicle to the end position of the regulation effective range. As an example, the remaining amount specifying unit 206 specifies the start remaining amount in a case where the distance from the vehicle position of the host vehicle to the start position of the regulation effective range is equal to or less than a setting value that can be arbitrarily set. The distance from the vehicle position of the host vehicle to the start position of the regulation effective range may be calculated from the vehicle position of the host vehicle acquired by the vehicle position acquisition unit 202 and the map data stored in the map database 4. Alternatively, the remaining amount specifying unit 206 may use the distance from the host vehicle to the start position of the regulation effective range specified by the mark specifying unit 204. In this case, the remaining amount specifying unit 206 may specify the start position of the regulation effective range from the fact that the mark specifying unit 204 has recognized the content of the auxiliary sign such as “from here” indicating the start position of the regulation effective range. Note that the remaining amount specifying unit 206 may be configured to sequentially specify the start remaining amount until the host vehicle enters the regulation effective range, or may be configured to specify the start remaining amount once in a case where the distance from the vehicle position of the host vehicle to the start position of the regulation effective range becomes equal to or less than a setting value that can be arbitrarily set.

In addition, the remaining amount specifying unit 206 may start specifying the end remaining amount in a case where the host vehicle enters the regulation effective range. The remaining amount specifying unit 206 may determine that the host vehicle has entered the regulation effective range from the fact that the mark specifying unit 204 specifies the content of the auxiliary sign such as “from here” indicating the start position of the regulation effective range. Alternatively, the remaining amount specifying unit 206 may determine that the host vehicle has entered the regulation effective range from the vehicle position of the host vehicle and the effective range data of the map data. As an example, the remaining amount specifying unit 206 may be configured to sequentially specify the end remaining amount for the regulation effective range up to the end position of the target regulation effective range. The remaining amount specifying unit 206 may determine the end position of the regulation effective range from the fact that the mark specifying unit 204 specifies the content of the auxiliary sign such as “up to here” indicating the end position of the regulation effective range, or may determine the end position of the regulation effective range from the fact that the specified remaining amount is 0.

When specifying the remaining travel distance as the start remaining amount, the remaining amount specifying unit 206 may specify the travel distance from the vehicle position of the host vehicle to the start position of the regulation effective range as the remaining travel distance. On the other hand, when specifying the remaining travel distance as the end remaining amount, the remaining amount specifying unit 206 may specify the remaining travel distance by subtracting the travel distance after the host vehicle enters the regulation effective range from the distance corresponding to the regulation effective range.

The remaining amount specifying unit 206 may specify the remaining travel time as the start remaining amount or the remaining travel time as the end remaining amount by dividing the remaining travel distance by the speed of the host vehicle acquired by the speed acquisition unit 201. As the speed of the host vehicle, an average speed in a predetermined period that can be arbitrarily set may be used.

In a case where the host vehicle is positioned within the regulation effective range indicated by the traffic regulation mark, the priority setting unit 207 sets the priority of the first content information indicating the content of the regulation in the regulation effective range. In other words, the priority setting unit 207 specifies the priority of the effective first content information in which the host vehicle is positioned within the regulation effective range.

As an example, the priority setting unit 207 may be configured to set the priority of the traffic regulation mark in accordance with the situation of the host vehicle with respect to the regulation effective range. Specifically, the priority setting unit 207 may be configured to set a higher priority for the traffic regulation mark with respect to the regulation effective range in which the remaining amount specified by the remaining amount specifying unit 206 is small. In addition, the priority setting unit 207 may be configured to perform setting according to selection from the driver received via the operation device 21. Note that the selection from the driver may be received via a microphone in a case where the voice recognition unit is used in the host vehicle. Alternatively, the priority setting unit 207 may be configured to set the priority of the traffic regulation mark in accordance with the type of the traffic regulation mark. In this case, the correspondence relationship between the type of the traffic regulation mark and the priority may be stored in advance in the nonvolatile memory of the vehicle display control device 20, and the priority setting unit 207 may set the priority of the traffic regulation mark by making reference to the correspondence relationship.

Moreover, the priority setting unit 207 may be configured to set the priority of the traffic regulation mark in accordance with the type of the traffic regulation mark and the traveling state of the host vehicle. In other words, the priority of the traffic regulation mark may be switched in accordance with the traveling state of the host vehicle. In this case, the priority setting unit 207 may be configured to set a higher priority for the traffic regulation mark estimated to be likely to be a target in the traveling state of the host vehicle. Note that the correspondence relationship between the type of the traffic regulation mark and the priority may be stored in advance in the nonvolatile memory of the vehicle display control device 20, and the priority setting unit 207 may set the priority of the traffic regulation mark by making reference to the correspondence relationship.

Examples of the traveling state of the host vehicle include the speed of the host vehicle and the presence or absence of a preceding vehicle. The speed of the host vehicle may be acquired by the speed acquisition unit 201, and the presence or absence of a preceding vehicle may be determined from the travel environment recognized by the recognition unit 203.

Examples of setting the priority of the traffic regulation mark according to the type of the traffic regulation mark and the traveling state of the host vehicle include the following. Here, as the traffic regulation mark, “speed limit”, “no parking”, and “no overtaking” will be described as examples. In a case where the speed of the host vehicle is less than the setting value, the priority of “no parking” may be set higher than the priority of “speed limit”. In a case where the speed of the host vehicle is equal to or greater than the setting value, the priority of “speed limit” may be set higher than the priority of “no parking”. In addition, in a case where there is a preceding vehicle, the priority of “no overtaking” may be set higher than the priority of “speed limit”. In a case where there is no preceding vehicle, the priority of “speed limit” may be set higher than the priority of “no overtaking”.

Note that the processing of setting the priority based on the situation of the host vehicle with respect to the regulation effective range will be described in detail later.

In addition, the priority setting unit 207 sets the priority of the second content information indicating the content other than the first content information. That is, the priority setting unit 207 sets the priority not only for the first content information but also for the second content information.

The second content information is, for example, warning information for giving a warning about an object positioned around the host vehicle. In this case, the correspondence relationship between the type of the object and the priority may be stored in advance in the nonvolatile memory of the vehicle display control device 20, and the priority setting unit 207 may set the priority of the warning information about the object by making reference to the correspondence relationship. As an example, in the nonvolatile memory of the vehicle display control device 20, priorities corresponding to four types of objects of pedestrians, bicycles, motorcycles, and cars are stored. The pedestrian may be given the highest priority because of high risk. The bicycle may be given the next highest priority. The motorcycle and the car may be given higher priority in this order. Note that the warning information may be given a single priority regardless of the type of the object.

In addition, the second content information may include, for example, guidance information for giving a guide to a route to a destination and abnormality information indicating that an abnormality has occurred in the host vehicle. In this case, the guidance information and the abnormality information are also given priorities, and these priorities are stored in advance in the nonvolatile memory of the vehicle display control device 20. Then, the priority setting unit 207 may be configured to set the priorities of the guidance information and the abnormality information by making reference to the stored priorities.

The display control unit 208 causes the HUD 220 to display the remaining amount information indicating the remaining amount in the regulation effective range specified by the remaining amount specifying unit 206, in addition to the first content information indicating the content of the regulation in the regulation effective range, in accordance with the situation of the host vehicle with respect to the regulation effective range. The first content information may be text information, an icon image, or a combination of them as long as the first content information indicates the content of the regulation of the regulation effective range. In the present embodiment, the following description will be continued by taking, as an example, a case where an icon image of a traffic regulation mark corresponding to the content of a regulation in the regulation effective range is used as the first content information. In addition, the remaining amount information may be text information, an image such as a bar graph, or a combination of them as long as the remaining amount information indicates the remaining amount. In the present embodiment, a case where text information indicating the remaining amount is used as the remaining amount information will be described as an example.

In addition, the display control unit 208 causes the HUD 220 to display the second content information. The second content information may be a text, an image such as an icon, or a combination of them as long as the second content information indicates a warning target object, a route to the destination, and occurrence of abnormality. In the present embodiment, a case where an icon image corresponding to a warning target object is used as warning information will be described as an example.

The display control unit 208 switches the display area in which the first content information and the remaining amount information are displayed between the proximal display area and the distal display area according to the situation of the host vehicle with respect to the regulation effective range. In addition, the display control unit 208 may display the latest first content information and remaining amount information in the distal display area and then transition to display in the proximal display area. However, in a case where the first content information and the remaining amount information are to be displayed in the proximal display area for a plurality of types of traffic regulation marks, the display control unit 208 performs adjustment to switch the display of the traffic regulation mark having a lower priority set by the priority setting unit 207 from the proximal display area to the distal display area. Moreover, in a case where the first content information and the remaining amount information in which the display area has been switched from the proximal display area to the distal display area exist for a plurality of types of traffic regulation marks, the display control unit 208 displays the information on the traffic regulation marks in the distal display area in order according to the priority set by the priority setting unit 207.

In addition, also in a case where the first content information and the second content information are to be displayed in the proximal display area, or in a case where they are to be displayed in the distal display area, the display control unit 208 performs adjustment to switch the display according to the priority set by the priority setting unit 207. Moreover, in a case where a plurality of pieces of the second content information is to be displayed in the proximal display area or in a case where they are to be displayed in the distal display area, the display control unit 208 performs adjustment to switch the display on the basis of the priority set by the priority setting unit 207. For example, in a case where the first content information or the second content information is to be displayed in the distal display area while the second content information is displayed in the distal display area, the display control unit 208 performs adjustment to switch the display of the information having a lower priority set by the priority setting unit 207 from the distal display area to the proximal display area. Note that, in this case, the display control unit 208 may reduce the size for displaying the information having a lower priority and display the information in the distal display area. In addition, the display control unit 208 may stop displaying information having a lower priority and display the information after it is no longer necessary to display information having a higher priority.

In addition, in a case where the first content information or the second content information is to be displayed in the proximal display area while the second content information is displayed in the proximal display area, the display control unit 208 performs adjustment to switch the display of the information having a lower priority set by the priority setting unit 207 from the proximal display area to the distal display area. Note that, in this case, if another piece of the first content information or the second content information is displayed in the distal display area, the display control unit 208 may reduce the size of the information to be displayed in the distal display area and display the other piece of the first content information or the second content information and the information switched from the proximal display area to the distal display area in the distal display area. In addition, the display control unit 208 may stop displaying information having a lower priority (which may correspond to “low priority information” in the claims) among the other piece of the first content information or the second content information and the information switched from the proximal display area to the distal display area.

In addition, in a case where the second content information is to be displayed in the distal display area while the first content information is displayed in the distal display area, the display control unit 208 performs adjustment to switch the display of the information having a lower priority set by the priority setting unit 207 from the distal display area to the proximal display area. Note that, in this case, the display control unit 208 may reduce the size for displaying the information having a lower priority and display the information in the distal display area. In addition, the display control unit 208 may stop displaying information having a lower priority and display the information after it is no longer necessary to display information having a higher priority.

In addition, in a case where the second content information is to be displayed in the proximal display area while the first content information is displayed in the proximal display area, the display control unit 208 performs adjustment to switch the display of the information having a lower priority set by the priority setting unit 207 from the proximal display area to the distal display area. Note that, in this case, if another piece of the first content information or the second content information is displayed in the distal display area, the display control unit 208 may reduce the size of the information to be displayed in the distal display area and display the other piece of the first content information or the second content information and the information switched from the proximal display area to the distal display area in the distal display area. In addition, the display control unit 208 may stop displaying information having a lower priority (which may correspond to “low priority information” in the claims) among the other piece of the first content information or the second content information and the information switched from the proximal display area to the distal display area.

Note that the control of the display control unit 208 is not limited to the above content in a case where the first content information and the second content information are to be displayed in the same display area, in a case where a plurality of pieces of the first content information is to be displayed in the same display area, or in a case where a plurality of pieces of the second content information is to be displayed in the same display area. For example, in a case where a plurality of pieces of information is to be displayed in the same display area, the display control unit 208 may alternately display the plurality of pieces of information at predetermined time intervals. In addition, in a case where a plurality of pieces of information is to be displayed in the proximal display area, the display control unit 208 may reduce the size of displaying the plurality of pieces of information and display these pieces of information in the proximal display area.

The display control of the first content information, the remaining amount information, and the second content information by the display control unit 208 will be described in detail later.

In addition, the display control unit 208 may be configured to switch whether to display information indicating the remaining travel distance or information indicating the remaining travel time as the remaining amount information according to the selection from the driver received via the operation device 21. Note that information indicating both the remaining travel distance and the remaining travel time may be displayed. Alternatively, the display control unit 208 may be configured to be capable of switching the presence or absence of display on the HUD 220 or selectively canceling the display of the first content information and the remaining amount information for a specific traffic regulation mark according to selection from the driver received via the operation device 21.

Regulation display control-related processing in vehicle display control device 20

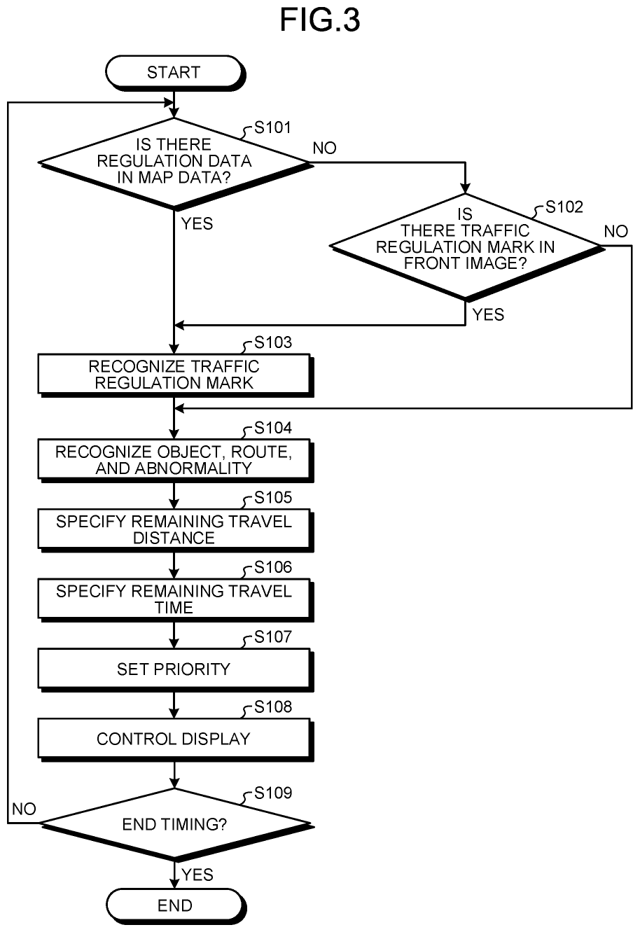

Next, an example of a flow of processing (hereinafter, referred to as regulation display control-related processing) related to the control of the display of the traffic regulation mark by the HUD 220 in the vehicle display control device 20 will be described with reference to FIG. 3. FIG. 3 is a flowchart illustrating an example of regulation display control-related processing of the vehicle display control device 20. In the flowchart of FIG. 3, the processing may be started in a case where the power of the HUD 220 is turned on and the function of the HUD 220 is turned on. The function of the HUD 220 may be switched on or off according to an input operation received by the operation device 21. In addition, the HUD 220 may be configured to be turned on or off according to on or off of a switch (hereinafter, referred to as a power switch) for starting an internal combustion engine or a motor generator of the host vehicle.

First, in step S101, the recognition unit 203 determines whether or not there is regulation data associated with a link on the traveling route ahead of the host vehicle in the map data. In a case where the recognition unit 203 determines that there is the regulation data (YES in step S101), the processing proceeds to step S103. On the other hand, in a case where the recognition unit 203 determines that there is no regulation data (NO in step S101), the processing proceeds to step S102.

In step S102, the recognition unit 203 determines whether or not the traffic regulation mark can be recognized from the front image. In a case where it is determined by the recognition unit 203 that the traffic regulation mark can be recognized (YES in step S102), the processing proceeds to step S103.

In step S103, the recognition unit 203 recognizes a traffic regulation mark located on the traveling route ahead of the host vehicle. Thereafter, the processing proceeds to step S104.

In addition, in a case where it is determined by the recognition unit 203 that the traffic regulation mark cannot be recognized (NO in step S102), the processing proceeds to step S104.

In step S104, the recognition unit 203 recognizes an object positioned around the host vehicle, a route from the current location to the destination, and occurrence of abnormality of the host vehicle. Thereafter, the processing proceeds to step S105.

In step S105, the remaining amount specifying unit 206 specifies the remaining travel distance as the start remaining amount or the end remaining amount. Before the host vehicle enters the target regulation effective range, the remaining amount specifying unit 206 specifies the remaining travel distance as the start remaining amount for the regulation effective range. On the other hand, after the host vehicle enters the regulation effective range, the remaining amount specifying unit 206 specifies the remaining travel distance as the end remaining amount for the regulation effective range. Thereafter, the processing proceeds to step S106.

In step S106, the remaining amount specifying unit 206 specifies the remaining travel time as the start remaining amount or the end remaining amount. Before the host vehicle enters the target regulation effective range, the remaining amount specifying unit 206 specifies the remaining travel time as the start remaining amount for the regulation effective range. On the other hand, after the host vehicle enters the regulation effective range, the remaining amount specifying unit 206 specifies the remaining travel time as the end remaining amount for the regulation effective range. Thereafter, the processing proceeds to step S107.

In step S107, the priority setting unit 207 sets priorities of the first content information and the second content information. At this time, in a case where there is a plurality of types of traffic regulation marks corresponding to the regulation effective range in which the host vehicle is positioned or in a case where there is a plurality of types of second content information, the priority setting unit 207 sets the priority of each of the first content information and the second content information indicating the content of the regulation of the plurality of types of traffic regulation marks. Thereafter, the processing proceeds to step S108.

In step S108, the display control unit 208 performs display control to display the first content information, the remaining amount information, and the second content information on the HUD 220. The display control unit 208 switches and displays the display area in which the first content information and the remaining amount information are displayed between the proximal display area and the distal display area according to the situation of the host vehicle with respect to the regulation effective range. In addition, in a case where there is a plurality of types of traffic regulation marks, the display control unit 208 adjusts the display of the first content information, the remaining amount information, and the second content information according to the priority set by the priority setting unit 207 in step S110. Moreover, also in a case where the first content information and the second content information are to be displayed in the proximal display area or in a case where they are to be displayed in the distal display area, the display control unit 208 performs adjustment to switch the display according to the priority set by the priority setting unit 207. In addition, in a case where a plurality of pieces of the second content information is to be displayed in the proximal display area or in a case where they are to be displayed in the distal display area, the display control unit 208 performs adjustment to switch the display according to the priority set by the priority setting unit 207. Thereafter, the processing proceeds to step S109.

In step S109, in a case where it is the end timing of the regulation display control-related processing (YES in step S109), the regulation display control-related processing ends. Examples of the end timing of the regulation display control-related processing include a case where the power switch of the host vehicle is turned off and a case where the function of the HUD 220 is turned off.

On the other hand, in a case where it is not the end timing of the regulation display control-related processing (NO in step S109), the processing returns to step S101, and the processing in and after step S101 are executed.

Display control example in case where there is one type of effective traffic regulation mark

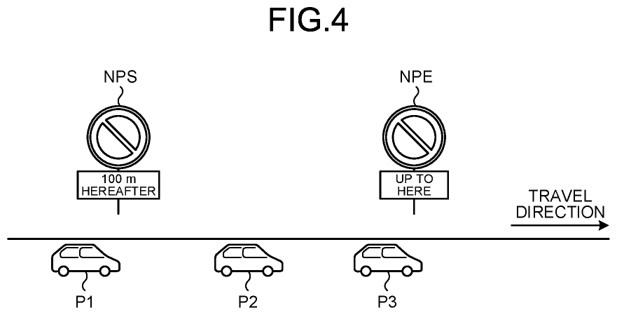

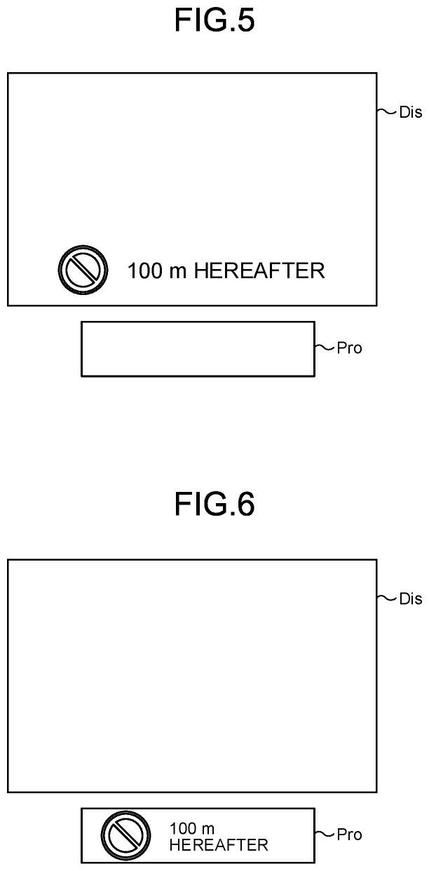

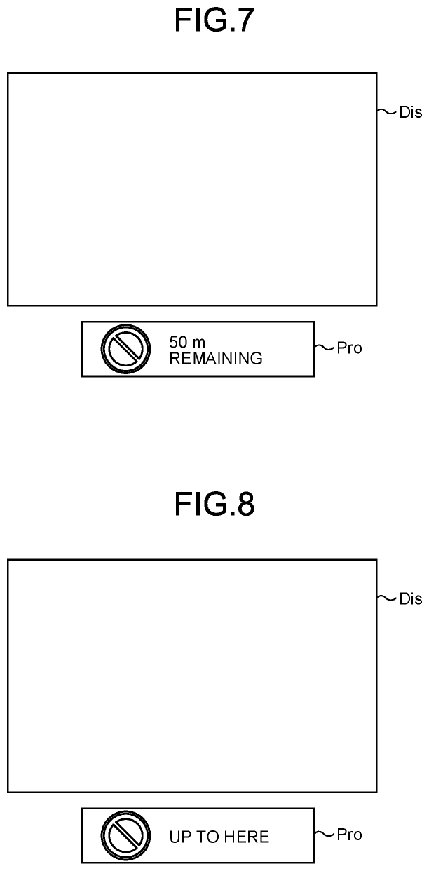

An example of display control by the display control unit 208 in a case where there is one type of effective traffic regulation mark will be described with reference to FIGS. 4 to 8. FIG. 4 is a schematic diagram illustrating an example of a situation of a host vehicle with respect to a regulation effective range. FIGS. 5 to 8 are diagrams each illustrating an example of display of the first content information and the remaining amount information in a proximal display area Pro and a distal display area Dis according to a traveling situation of the host vehicle in FIG. 4. FIGS. 5 and 6 are diagrams each illustrating an example of display at a vehicle position P1, FIG. 7 is a diagram illustrating a vehicle position P2, and FIG. 8 is a diagram illustrating an example of display at a vehicle position P3. In FIGS. 4 to 8, a case where the traffic regulation mark is “no parking” and the regulation effective range is 100 m will be described as an example.

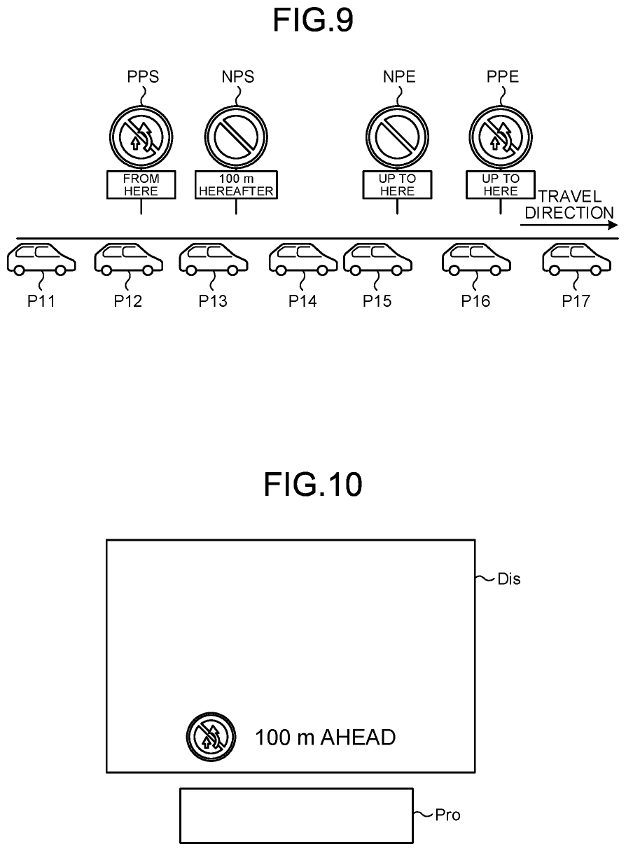

FIG. 4 illustrates a sign NPS such as a “no parking” regulation sign and an auxiliary sign provided at a start position of a regulation effective range. In addition, FIG. 4 illustrates a sign NPE such as a “no parking” regulation sign and an auxiliary sign provided at an end point position of a regulation effective range. FIG. 4 illustrates the vehicle positions P1 to P3 of the host vehicle. The vehicle position P1 indicates a vehicle position at which the sign NPS and the front part of the host vehicle are positioned at the same position, that is, a vehicle position at the time when the host vehicle enters the regulation effective range (hereinafter, referred to as a regulation effective range of “no parking”) corresponding to the regulation sign of “no parking”. The vehicle position P2 indicates a vehicle position in a case where the host vehicle is positioned between the sign NPS and the sign NPE, that is, a vehicle position in a case where the host vehicle is positioned within the regulation effective range of “no parking”. The vehicle position P3 indicates a vehicle position in a case where the host vehicle passes through the sign NPE, that is, a vehicle position at the time of exiting the regulation effective range of “no parking”. Note that the same applies to FIGS. 9 to 19 described below.

In a case where the host vehicle enters the regulation effective range of “no parking” (vehicle position P1 in FIG. 4), as illustrated in FIG. 5, the display control unit 208 displays an icon image imitating a sign of “no parking” as the first content information and a text such as “100 m hereafter” as the remaining amount information indicating the end remaining amount in the distal display area Dis. As a result, it is possible to cause the driver to recognize the newly specified traffic regulation mark. The display of the first content information and the remaining amount information at this time is displayed on the lower side of the distal display area Dis not to obstruct the field of view of the driver. However, this display is temporary, and the display control unit 208 then switches the display to the display in the proximal display area Pro for the first content information and the remaining amount information as illustrated in FIG. 6.

After the host vehicle enters the regulation effective range of “no parking” until the time of exiting (vehicle position P2 in FIG. 4), as illustrated in FIG. 7, an icon image imitating a sign of “no parking” and a text such as “50 m remaining” indicating an end remaining amount are displayed in the proximal display area Pro. The text indicating the end remaining amount may be updated and displayed according to the end remaining amount sequentially specified by the remaining amount specifying unit 206. The same applies to a display control example in a case where there are two types of effective traffic regulation marks and a display control example in a case where there are three or more types of effective traffic regulation marks described below.

Then, at the time when the host vehicle exits the regulation effective range of “no parking” (vehicle position P3 in FIG. 4), the display control unit 208 displays an icon image imitating a sign of “no parking” and a text such as “up to here” as an end remaining amount in the proximal display area Pro, as illustrated in FIG. 8. That is, it indicates that the traffic regulation mark of “no parking” becomes ineffective. The text to be displayed as the end remaining amount may be configured to display the content recognized from the auxiliary sign provided at the end point of the regulation effective range. In addition, the text to be displayed as the end remaining amount may be “0 m remaining” and the like. The same applies to a display control example in a case where there are two types of effective traffic regulation marks and a display control example in a case where there are three or more types of effective traffic regulation marks described below.

In a case where the host vehicle has exited the regulation effective range of “no parking”, the display control unit 208 deletes the first content information and the remaining amount information that have been displayed in the proximal display area Pro. That is, the display of the first content information and the remaining amount information corresponding to the regulation effective range where the host vehicle has exit is ended. Note that the display control unit 208 may be configured to display, in the distal display area Dis together with the first content information, remaining amount information indicating a start remaining amount for the regulation effective range before the host vehicle enters the regulation effective range for the purpose of giving notice of entry into the regulation effective range to the driver.

Display control example in case where there are two types of effective traffic regulation marks

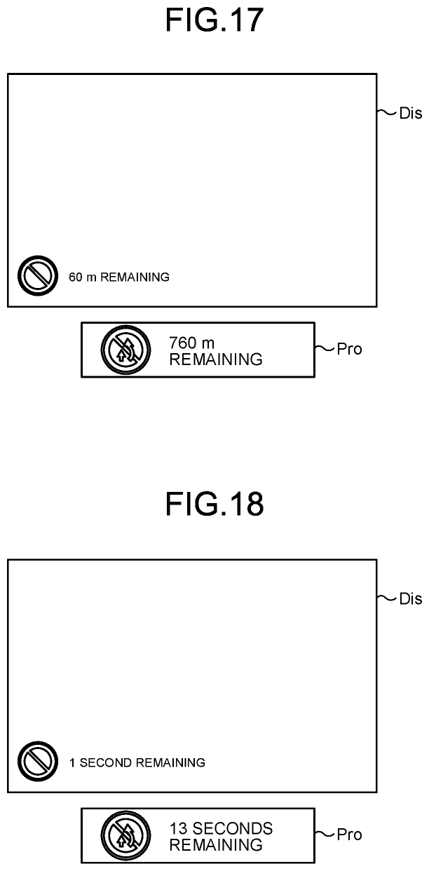

An example of display control by the display control unit 208 in a case where there are two types of effective traffic regulation marks will be described with reference to FIGS. 9 to 18. In FIGS. 9 to 18, a case where the traffic regulation marks are “no overtaking” and “no parking”, the regulation effective range of “no overtaking” is 800 m, and the regulation effective range of “no parking” is 100 m will be described as an example. In addition, in FIGS. 9 to 18, a case where the regulation effective ranges of “no parking” overlap with each other in the middle of the regulation effective range of “no overtaking” will be described as an example. FIG. 9 is a schematic diagram illustrating an example of a situation of the host vehicle with respect to the regulation effective range. FIGS. 10 to 18 are diagrams illustrating an example of display of the first content information and the remaining amount information in a proximal display area Pro and a distal display area Dis according to a traveling situation of the host vehicle in FIG. 9. Specifically, FIGS. 10 to 16 are diagrams illustrating examples of display at the vehicle positions P11 to P17, respectively, and FIGS. 17 and 18 are diagrams illustrating another example of display at the vehicle position P14.

In the example of FIG. 9, the sign NPS illustrates a sign such as a “no parking” regulation sign and an auxiliary sign provided at a start position of the regulation effective range of “no parking”. In addition, the sign NPE illustrates a sign such as a “no parking” regulation sign and an auxiliary sign provided at an end point position of the regulation effective range. Moreover, in the example of FIG. 9, a sign PPS illustrates a sign such as a “no overtaking” regulation sign and an auxiliary sign provided at a start position of the regulation effective range of “no overtaking”. In addition, a sign PPE illustrates a sign such as a “no overtaking” regulation sign and an auxiliary sign provided at an end point position of the regulation effective range.

FIG. 9 illustrates the vehicle positions P11 to P17 of the host vehicle. The vehicle position P11 indicates a vehicle position before the host vehicle enters the regulation effective range of “no overtaking”. The vehicle position P12 indicates a vehicle position at which the sign PPS and the front part of the host vehicle are positioned at the same position, that is, a vehicle position at the time when the host vehicle enters the regulation effective range (hereinafter, referred to as a regulation effective range of “no overtaking”) corresponding to the regulation sign of “no overtaking”. The vehicle position P13 indicates a vehicle position where the sign NPS and the front part of the host vehicle are positioned at the same position, that is, a vehicle position when the host vehicle enters the regulation effective range of “no parking”. The vehicle position P14 indicates a vehicle position in a case where the host vehicle is positioned within both the regulation effective range of “no overtaking” and the regulation effective range of “no parking”. The vehicle position P15 indicates a vehicle position in a case where the host vehicle passes through the sign NPE, that is, a vehicle position at the time of exiting the regulation effective range of “no parking”. The vehicle position P16 indicates a vehicle position in a case where the host vehicle passes through the sign PPE, that is, a vehicle position at the time of exiting the regulation effective range of “no overtaking”. The vehicle position P17 indicates a vehicle position after exiting the regulation effective range of “no overtaking”. Before the host vehicle enters the regulation effective range of “no overtaking” (vehicle position P11 in FIG. 9), as illustrated in FIG. 10, the display control unit 208 displays an icon image imitating a sign of “no overtaking” as the first content information and a text such as “100 m ahead” as the remaining amount information indicating the start remaining amount in the distal display area Dis.

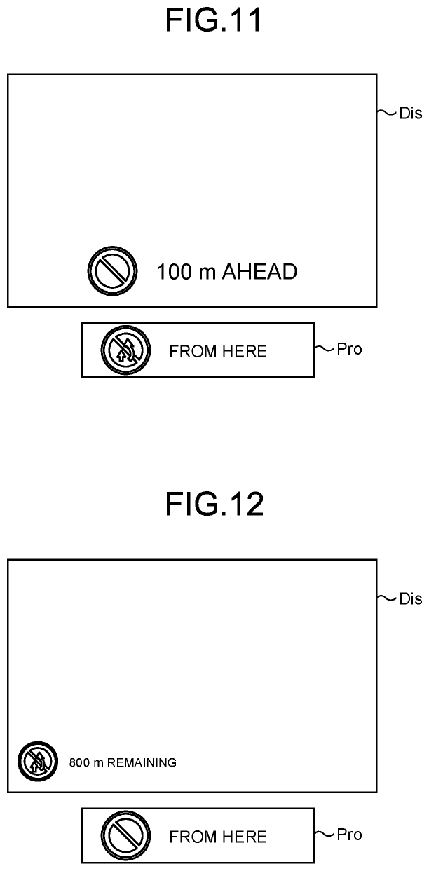

In a case where the host vehicle enters the regulation effective range of “no overtaking” (vehicle position P12 in FIG. 5), as illustrated in FIG. 11, the display control unit 208 displays, in the proximal display area Pro, an icon image imitating a sign of “no overtaking” as the first content information and a text indicating that the regulation effective range starts, such as “from here”. The display control unit 208 displays an icon image imitating a sign of “no parking” as the first content information and a text such as “100 m ahead” as the remaining amount information indicating the start remaining amount in the distal display area Dis.

Note that the display control unit 208 may be configured to display a text such as “800 m hereafter” as the remaining amount information indicating the end remaining amount instead of displaying the text indicating the start of the regulation effective range in the proximal display area Pro. In addition, it may be configured such that display of a text such as “from here” is temporarily displayed and then switching to display of a text such as “800 m hereafter” is performed.

Next, in a case where the host vehicle enters the regulation effective range of “no parking” (vehicle position P13 in FIG. 9), as illustrated in FIG. 12, the display control unit 208 displays, in the proximal display area Pro, an icon image imitating a sign of “no parking” as the first content information corresponding to the newly effective traffic regulation mark, and a text indicating that the regulation effective range starts, such as “from here”. The display control unit 208 displays an icon image imitating a sign of “no overtaking” as the first content information corresponding to the traffic regulation mark that has already been effective and a text such as “800 m remaining” as the remaining amount information indicating the end remaining amount in the distal display area Dis. Note that the display control unit 208 may be configured to transition the information corresponding to the traffic regulation mark that has already been effective from the display in the proximal display area Pro to the display in the distal display area Dis as the information corresponding to the traffic regulation mark that is newly made effective is displayed in the proximal display area Pro.

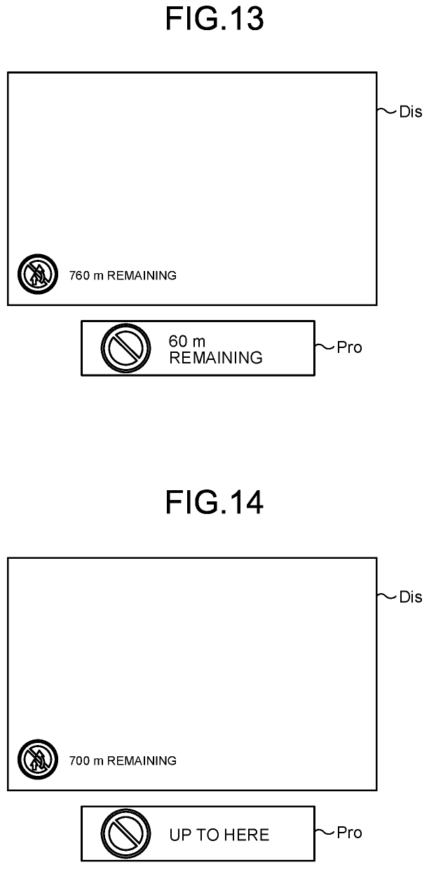

In a case where the host vehicle is positioned in an area in which the regulation effective range of “no overtaking” and the regulation effective range of “no parking” overlap with each other (vehicle position P14 in FIG. 9), as illustrated in FIG. 13, the display control unit 208 displays, in the proximal display area Pro, an icon image imitating a sign of “no parking” and a text such as “60 m remaining” indicating the end remaining amount, the icon image corresponding to the regulation effective range of “no parking” having a smaller end remaining amount. On the other hand, the display control unit 208 displays, in the distal display area Dis, an icon image imitating a sign of “no overtaking” corresponding to the regulation effective range of “no overtaking” in which the end remaining amount is larger, and text such as “760 m remaining” indicating the end remaining amount. According to this, since the first content information and the remaining amount information for the regulation effective range in which the end remaining amount is smaller are preferentially displayed in the proximal display area Pro, the driver can more easily recognize the situation of the host vehicle for each regulation effective range indicated by the plurality of types of traffic regulation marks.

The display control unit 208 may be configured to display information on a traffic regulation mark having a higher priority set by the priority setting unit 207 in the proximal display area Pro, and display information on a traffic regulation mark having a lower priority in the distal display area Dis. In a case where the display area in which the first content information and the remaining amount information about the traffic regulation mark having a lower priority are displayed is switched from the proximal display area Pro to the distal display area Dis, the display control unit 208 displays the first content information and the remaining amount information to be displayed in the distal display area Dis in a more inconspicuous manner than the case where the first content information and the remaining amount information are initially displayed in the distal display area Dis.

The term “initially” as used herein refers to a point in time when the host vehicle enters the regulation effective range for the traffic regulation mark. In addition, examples of the inconspicuous mode include a display mode in which the display size is reduced, a display mode in which the display luminance is reduced, and a display mode in which the display position is set to a position more deviated from the center of the distal display area Dis. According to this, it is possible to make it easier for the driver to distinguish the information displayed in the distal display area Dis at the time of entering the regulation effective range from the information to be displayed in the distal display area Dis while preventing the field of view of the driver from being obstructed.

Then, at the time when the host vehicle exits the regulation effective range of “no parking” (vehicle position P15 in FIG. 9), the display control unit 208 displays an icon image imitating a sign of “no parking” and a text such as “up to here” as an end remaining amount in the proximal display area Pro, as illustrated in FIG. 14. That is, it indicates that the traffic regulation mark of “no parking” becomes ineffective. The display control unit 208 causes the distal display area Dis to continuously display the first content information and the remaining amount information corresponding to the regulation effective range of “no overtaking”. As a specific example, the display control unit 208 displays an icon image imitating a sign of “no overtaking” and a text such as “700 m remaining” indicating the end remaining amount.

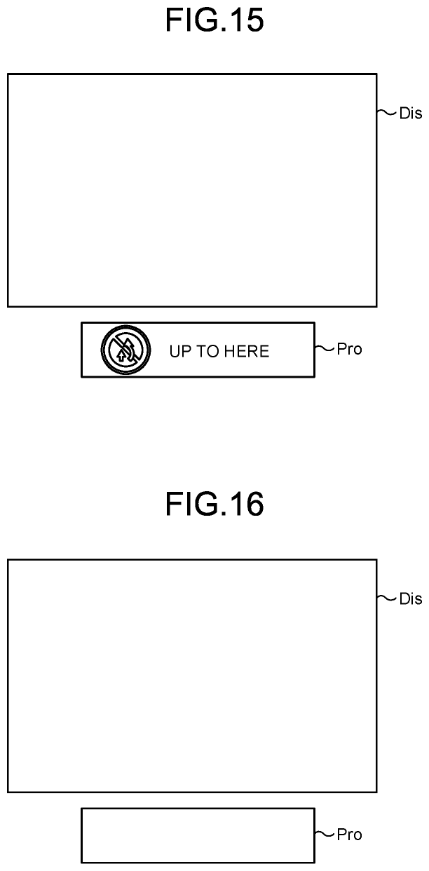

At the time when the host vehicle exits the regulation effective range of “no overtaking” (vehicle position P16 in FIG. 9), the display control unit 208 displays an icon image imitating a sign of “no overtaking” and a text such as “up to here” as an end remaining amount in the proximal display area Pro, as illustrated in FIG. 15. That is, it indicates that the traffic regulation mark of “no overtaking” becomes ineffective. The display control unit 208 ends the display of the first content information and the remaining amount information corresponding to the regulation effective range of “no overtaking” in the distal display area Dis.

In a case where the host vehicle has exited the regulation effective range of “no overtaking” (vehicle position P17 in FIG. 9), as illustrated in FIG. 16, the display control unit 208 deletes the first content information and the remaining amount information that have been displayed in the proximal display area Pro. In addition, since there is no effective traffic regulation mark, the display control unit 208 does not display the first content information and the remaining amount information also in the distal display area Dis as illustrated in FIG. 16.

Note that, in FIG. 13, an example of a case where the priority of the traffic regulation mark having a smaller end remaining amount is made higher is illustrated, but the present invention is not necessarily limited to this. Depending on the setting of the priority in the priority setting unit 207, as illustrated in FIG. 17, the first content information and the remaining amount information corresponding to the regulation effective range of “no overtaking” may be displayed in the proximal display area Pro, and the first content information and the remaining amount information corresponding to the regulation effective range of “no parking” may be displayed in the distal display area Dis.

In addition, in FIGS. 5 to 8 and FIGS. 10 to 17, the remaining travel distance is displayed as the start remaining amount and the end remaining amount, but the present invention is not necessarily limited to this. For example, as illustrated in FIG. 18, the remaining travel time may be displayed as the remaining amount.

Display control example in case where there are three or more types of effective traffic regulation marks

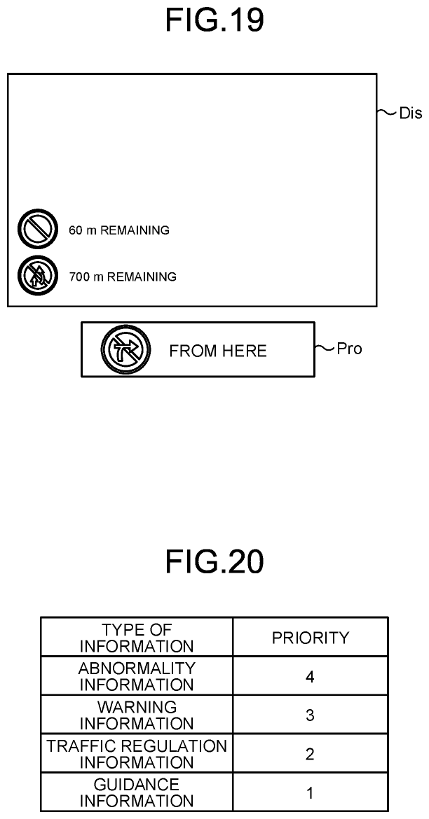

An example of display control by the display control unit 208 in a case where there are three or more types of effective traffic regulation marks will be described with reference to FIG. 19. FIG. 19 is a diagram illustrating another example of display of the first content information and the remaining amount information in a proximal display area Pro and a distal display area Dis according to a traveling situation of the host vehicle. In FIG. 19, a case where there are three types of traffic regulation marks of “no overtaking”, “no parking”, and “no vehicle crossing” will be described as an example. Note that the case other than the case where the regulation effective ranges of the three types of traffic regulation marks overlap with each other is similar to the case where there are two or more types of effective traffic regulation marks described above, and thus the description will be omitted.

In a case where the host vehicle is positioned in an area where the regulation effective range of “no overtaking”, the regulation effective range of “no parking”, and the regulation effective range of “no vehicle crossing” overlap with each other, the display control unit 208 displays the first content information and the remaining amount information on the traffic regulation mark having the highest priority set by the priority setting unit 207 in the proximal display area Pro. On the other hand, the display control unit 208 may be configured to display the first content information and the remaining amount information of the remaining traffic regulation marks in the distal display area Dis in order from the one having the highest priority set by the priority setting unit 207 to the one closer to the proximal display area Pro.

According to this, the driver can more easily recognize the situation of the host vehicle with respect to the respective regulation effective ranges indicated by the three or more types of traffic regulation marks by arranging the traffic regulation marks in the order of the set priorities. For example, in a case where the priority of the traffic regulation mark with respect to the regulation effective range in which the end remaining amount is smaller is set to be higher, the information on the regulation effective range in which the end remaining amount is smaller is displayed at a position closer to the proximal display area Pro, in a manner that the driver can intuitively recognize the order of the remaining amount with respect to each regulation effective range.

In addition, the display control unit 208 may display the first content information and the remaining amount information for the traffic regulation mark having a higher priority set by the priority setting unit 207 in a larger size or in a higher luminance to achieve a similar effect.

Display control example in a case where second content information is displayed

An example of display control by the display control unit 208 in a case where the second content information is displayed will be described with reference to FIGS. 20 to 31. Hereinafter, for convenience of description, an example will be described in which the nonvolatile memory of the vehicle display control device 20 stores priorities corresponding to four types of content information: traffic regulation information that is first content information; and warning information, guidance information, and abnormality information that are second content information. FIG. 20 is a schematic diagram illustrating information stored in a nonvolatile memory of the vehicle display control device 20 according to the embodiment. As illustrated in FIG. 20, the nonvolatile memory of the vehicle display control device 20 stores priorities corresponding to information of four types of content of traffic regulation information, warning information, guidance information, and abnormality information, and a larger number indicates a higher priority. For example, since a situation in which an abnormality occurs in the host vehicle is highly dangerous, “4” which is the highest priority is assigned to the abnormality information. Note that the display of the type of information and the priority is not limited to the above, and the definition of the priority may be set in a manner that a smaller number have a higher priority.

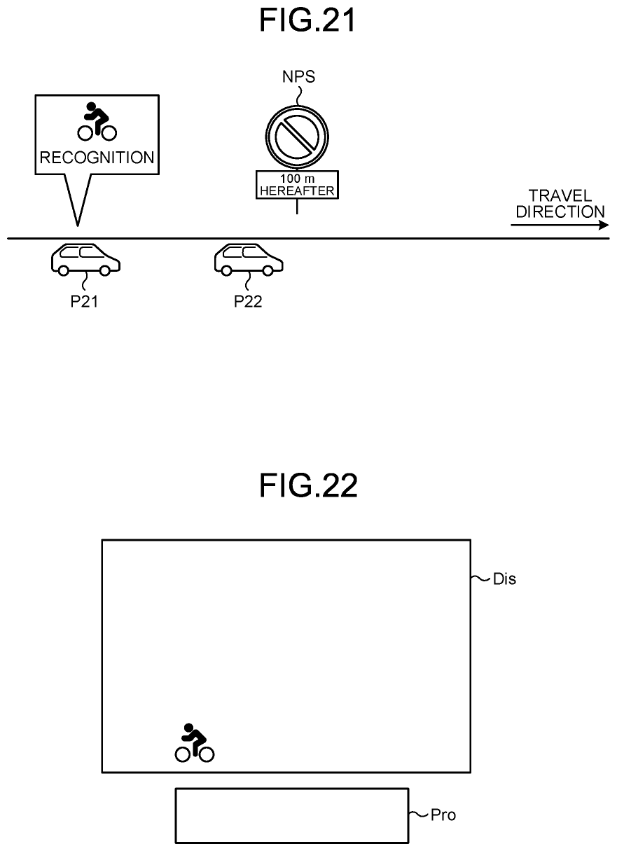

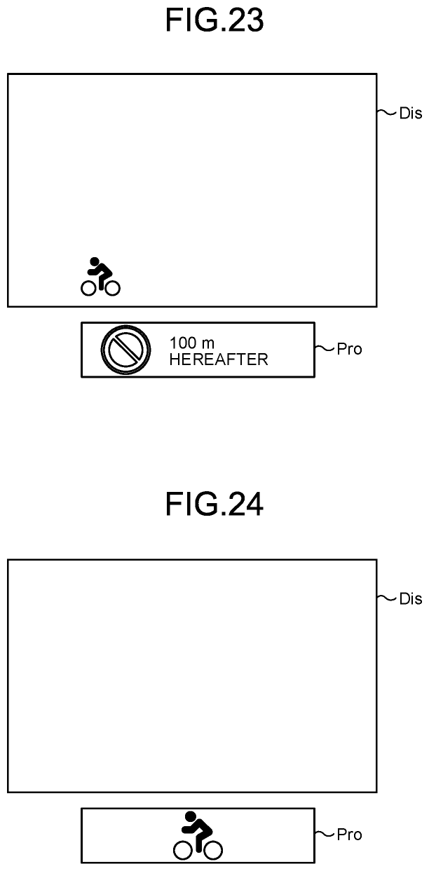

FIG. 21 is a schematic diagram illustrating another example of a situation of the host vehicle with respect to a regulation effective range. FIGS. 22 and 23 are diagrams each illustrating an example of display of the first content information, the remaining amount information, and the second content information in a proximal display area Pro and a distal display area Dis according to a traveling situation of the host vehicle in FIG. 21. FIG. 22 is a diagram illustrating an example of display at the vehicle position P21, and

FIG. 23 is a diagram illustrating an example of display at the vehicle position P22. In FIGS. 21 to 23, a case where the traffic regulation mark is “no parking”, the regulation effective range is 100 m, and the object present around the host vehicle is a “bicycle” will be described as an example.

In the example of FIG. 21, the sign NPS illustrates a sign such as a “no parking” regulation sign and an auxiliary sign provided at a start position of the regulation effective range of “no parking”.

FIG. 21 illustrates the vehicle positions P21 and P22 of the host vehicle. The vehicle position P21 indicates a vehicle position at the time when the host vehicle recognizes a “bicycle” that is present around the host vehicle. The vehicle position P22 indicates a vehicle position where the sign NPS and the front part of the host vehicle are positioned at the same position, that is, a vehicle position when the host vehicle enters the regulation effective range of “no parking”.

In a case where the host vehicle recognizes a bicycle present around the host vehicle (vehicle position P21 in FIG. 21), the display control unit 208 displays an icon image imitating “bicycle” as warning information in the distal display area Dis as illustrated in FIG. 22. For example, the display control unit 208 displays the icon image of “bicycle” in a manner that the icon image of “bicycle” overlaps with the bicycle present ahead of the host vehicle when viewed from the driver. As a result, the newly recognized object can be recognized by the driver. Note that the display control unit 208 may display the icon image of “bicycle” near the existing bicycle or may display the icon image of “bicycle” on the lower side of the distal display area Dis in a manner that the icon image of “bicycle” does not overlap with the bicycle present ahead of the host vehicle when viewed from the driver.

In a case where the host vehicle recognizes a bicycle present around the host vehicle and the host vehicle enters the regulation effective range of “no parking” (vehicle position P22 in FIG. 21), the display control unit 208 displays an icon image imitating “bicycle” as warning information having a higher priority in the distal display area Dis as illustrated in FIG. 23. On the other hand, the display control unit 208 displays an icon image imitating a sign of “no parking” as the first content information with a lower priority and a text such as “100 m hereafter” as the remaining amount information indicating the end remaining amount in the proximal display area Pro. In a case where the host vehicle enters the regulation effective range of “no parking” and there is no information to be displayed other than this “no parking”, as illustrated in FIG. 5, the display control unit 208 displays an icon image imitating a sign of “no parking” as the first content information and a text such as “100 m hereafter” as the remaining amount information indicating the end remaining amount in the distal display area Dis. Here, these pieces of information are displayed in the proximal display area Pro. According to this, the warning information having a higher priority is preferentially displayed in the distal display area Dis. Therefore, for example, by displaying an image indicating the warning information to be overlapped with a warning target object present ahead of the host vehicle when viewed from the driver, or by displaying the image in the vicinity of the warning target object, the driver can easily associate the image indicating the warning information with the target object of the warning present ahead of the host vehicle, and the driver can more easily recognize the target object of the warning and the position.

Note that, in a case where the host vehicle recognizes a bicycle present around the host vehicle (vehicle position P21 in FIG. 21), the display control unit 208 displays an icon image imitating “bicycle” as warning information in the proximal display area Pro as illustrated in FIG. 24. This also allows the driver to recognize the newly recognized object.

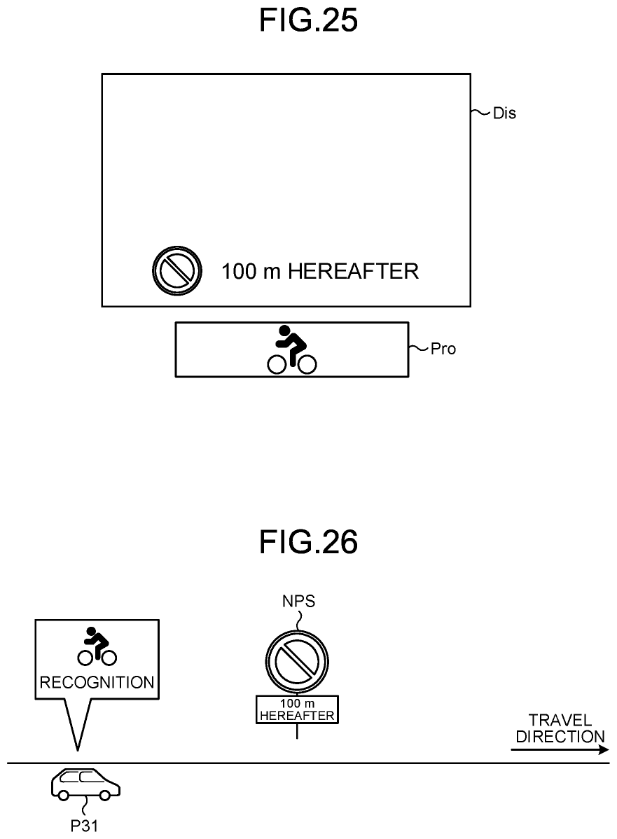

Then, in a case where the host vehicle recognizes a bicycle present around the host vehicle and the host vehicle enters the regulation effective range of “no parking” (vehicle position P22 in FIG. 21), as illustrated in FIG. 25, the display control unit 208 displays an icon image imitating a sign of “no parking” as the first content information corresponding to the traffic regulation mark that becomes newly effective, and a text such as “100 m hereafter” as the remaining amount information indicating the end remaining amount in the distal display area Dis. The display control unit 208 displays, in the proximal display area Pro, an icon image imitating “bicycle” as the warning information already displayed in the proximal display area Pro. In a case where there is no information to be displayed other than “no parking”, the display control unit 208 switches the display to the display of the first content information and the remaining amount information in the proximal display area Pro as illustrated in FIG. 6, but displays these pieces of information in the distal display area Dis. According to this, the warning information with higher priority is preferentially displayed in the proximal display area Pro, in a manner that the driver can more easily recognize the warning information having a higher priority.

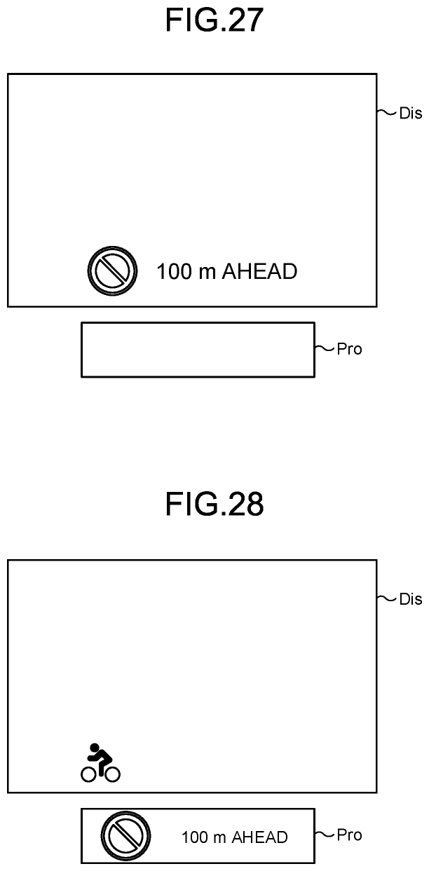

FIG. 26 is a schematic diagram illustrating another example of a situation of the host vehicle with respect to a regulation effective range. FIGS. 27 and 28 are diagrams illustrating an example of display of the first content information, the remaining amount information, and the second content information in a proximal display area Pro and a distal display area Dis according to a traveling situation of the host vehicle in FIG. 26. FIGS. 27 and 28 are diagrams illustrating an example of display at the vehicle position P31. In

FIGS. 26 to 28, a case where the traffic regulation mark is “no parking”, the regulation effective range is 100 m, and the object present around the host vehicle is a “bicycle” will be described as an example.

In the example of FIG. 26, the sign NPS illustrates a sign such as a “no parking” regulation sign and an auxiliary sign provided at a start position of the regulation effective range of “no parking”.

FIG. 26 illustrates the vehicle position P31 of the host vehicle. The vehicle position P31 indicates a vehicle position before the host vehicle enters the regulation effective range of “no parking”.

Before the host vehicle enters the regulation effective range of “no parking” (vehicle position P31 in FIG. 26), as illustrated in FIG. 27, the display control unit 208 displays an icon image imitating a sign of “no parking” as the first content information and a text such as “100 m ahead” as the remaining amount information indicating the start remaining amount in the distal display area Dis.

In the vehicle position P31 in FIG. 26, in a case where the host vehicle recognizes a bicycle present around the host vehicle, the display control unit 208 displays an icon image imitating “bicycle” as warning information having a higher priority in the distal display area Dis as illustrated in FIG. 28. On the other hand, the display control unit 208 displays an icon image imitating a sign of “no parking” as the first content information having a lower priority and a text such as “100 m ahead” as the remaining amount information indicating the start remaining amount in the proximal display area Pro. Before the host vehicle enters the regulation effective range of “no parking” and there is no information to be displayed other than this “no parking”, as in the icon image imitating the sign “no overtaking” illustrated in FIG. 10, the display control unit 208 displays an icon image imitating a sign of “no parking” as the first content information and a text such as “100 m ahead” as the remaining amount information indicating the start remaining amount in the distal display area Dis. Here, these pieces of information are displayed in the proximal display area Pro. According to this, the warning information having a higher priority is preferentially displayed in the distal display area Dis. Therefore, for example, by displaying an image indicating the warning information to be overlapped with a warning target object present ahead of the host vehicle when viewed from the driver, or by displaying the image in the vicinity of the warning target object, the driver can easily associate the image indicating the warning information with the target object of the warning present ahead of the host vehicle, and the driver can more easily recognize the target object of the warning and the position.

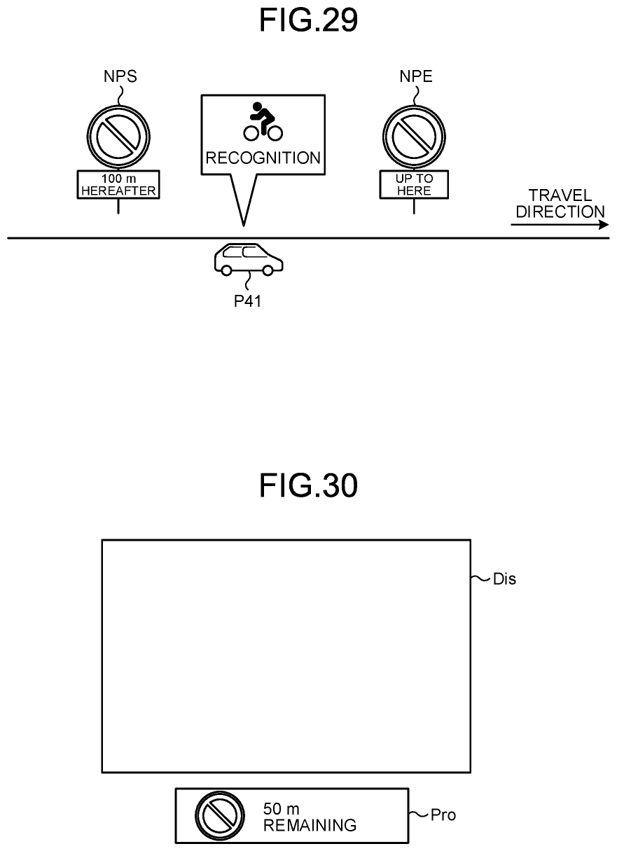

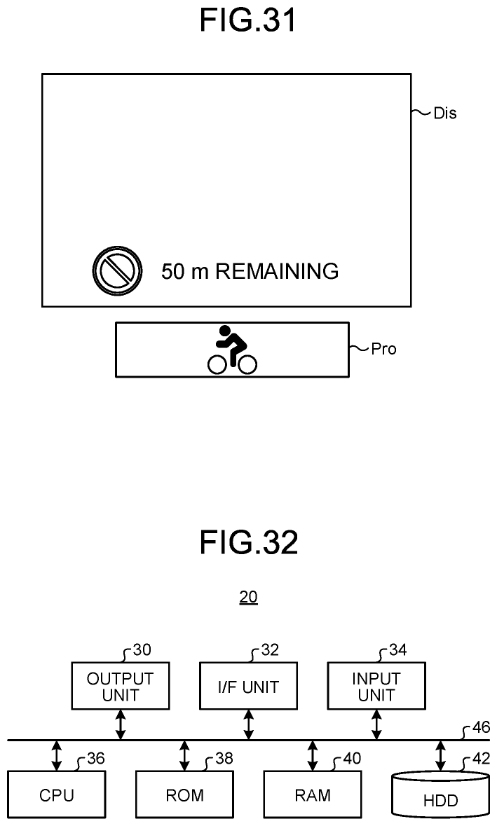

Note that, in a case where the host vehicle recognizes a bicycle present around the host vehicle, the display control unit 208 may display an icon image imitating “bicycle” as warning information in the proximal display area Pro. FIG. 29 is a schematic diagram illustrating another example of a situation of the host vehicle with respect to a regulation effective range. FIGS. 30 and 31 are diagrams each illustrating an example of display of the first content information, the remaining amount information, and the second content information in a proximal display area Pro and a distal display area Dis according to a traveling situation of the host vehicle in FIG. 29. FIGS. 30 and 31 are diagrams illustrating an example of display at the vehicle position P41. In FIGS. 29 to 31, a case where the traffic regulation mark is “no parking”, the regulation effective range is 100 m, and the object present around the host vehicle is a “bicycle” will be described as an example.

In the example of FIG. 29, the sign NPS illustrates a sign such as a “no parking” regulation sign and an auxiliary sign provided at a start position of the regulation effective range of “no parking”. In addition, the sign NPE illustrates a sign such as a “no parking” regulation sign and an auxiliary sign provided at an end point position of the regulation effective range of “no parking”.

FIG. 29 illustrates the vehicle position P41 of the host vehicle. The vehicle position P41 indicates a vehicle position in a case where the host vehicle is positioned between the sign NPS and the sign NPE, that is, a vehicle position in a case where the host vehicle is positioned within the regulation effective range of “no parking”.

After the host vehicle enters the regulation effective range of “no parking” until the time of exiting (vehicle position P41 in FIG. 29), as illustrated in FIG. 30, the display control unit 208 displays, an icon image imitating a sign of “no parking” as the first content information and a text such as “50 m remaining” as the remaining amount information indicating the end remaining amount in the proximal display area Pro. The text indicating the end remaining amount may be updated and displayed according to the end remaining amount sequentially specified by the remaining amount specifying unit 206.

In the vehicle position P41 in FIG. 29, in a case where the host vehicle recognizes a bicycle present around the host vehicle, the display control unit 208 displays an icon image imitating “bicycle” as warning information having a higher priority in the proximal display area Pro as illustrated in FIG. 31. On the other hand, the display control unit 208 displays an icon image imitating a sign of “no parking” as the first content information having a lower priority and a text such as “50 m remaining” as the remaining amount information indicating the end remaining amount in the distal display area Dis. In a case where there is no information to be displayed other than this “no parking” after the host vehicle enters the regulation effective range of “no parking” until the time of exiting, as illustrated in FIG. 7, the display control unit 208 displays an icon image imitating a sign of “no parking” as the first content information and a text such as “50 m remaining” as the remaining amount information indicating the end remaining amount in the proximal display area Pro. Here, these pieces of information are displayed in the distal display area Dis. According to this, the warning information with higher priority is preferentially displayed in the proximal display area Pro, in a manner that the driver can more easily recognize the warning information having a higher priority.

Note that, in the above example, the description has been given by exemplifying “no overtaking”, “no parking”, and “no vehicle crossing” as the traffic regulation marks, but the traffic regulation marks are not necessarily limited to this. The traffic regulation mark may be applied to another traffic regulation mark such as “speed limit” as long as a regionally effective range is defined in the regulation indicated by the traffic regulation mark.

### Conclusion

As described above, in the vehicle display control device 20 according to the present embodiment, the display control unit 208 controls display of the first content information and the second content information in the display area on the basis of the priorities given to the first content information and the second content information. The first content information indicates the content of the regulation in the effective range of regulation indicated by the traffic regulation mark in a case where the host vehicle enters the effective range of regulation. The second content information indicates the content other than that of the first content information.

With this configuration, in a case where the first content information and the second content information are both displayed, the display control unit 208 can appropriately display the first content information and the second content information in a manner that they do not overlap with each other. Therefore, according to the present embodiment, the driver can more easily recognize the contents indicated by the first content information and the second content information, and display of the first content information and the second content information more appropriate for the driver can be implemented.

In particular, in the display device 22 provided in the vehicle, the size of the display area is limited. In addition, in a case where there is a plurality of display areas, there may be a display area suitable for display according to information from the viewpoint of driver visibility, for example. Therefore, in the conventional vehicle display control device, there is a possibility that appropriate display cannot be performed in a case where display areas suitable for each of a plurality of pieces of information overlap with each other, such as a case where information other than the content of the regulation indicated by the traffic regulation mark is displayed. According to the vehicle display control device 20 of the present embodiment, a plurality of pieces of information including the first content information, the second content information, and the like can be appropriately displayed on the display device 22.

For example, in a case where the second content information is displayed in the distal display area or the proximal display area while the first content information is displayed in the same display area as the second content information, or in a case where the first content information is displayed in the distal display area or the proximal display area while the second content information is displayed in the same display area as the first content information, the display control unit 208 switches the display area for information having a lower priority between the first content information and the second content information. As a result, display control is performed on the basis of the priority set by the priority setting unit 207, and information having a higher priority is preferentially displayed. Therefore, according to the present embodiment, the driver can more easily recognize information having a higher priority, and display of the first content information and the second content information more appropriate for the driver can be implemented.

### Other Embodiments

In the foregoing embodiment, the priorities corresponding to the first content information and the second content information are stored in advance in the nonvolatile memory of the vehicle display control device 20. Alternatively, the priorities of the first content information and the second content information may be changed dynamically. For example, the priority setting unit 207 may set the priority of the warning information to be higher as the distance from the host vehicle to the warning target object is shorter. In addition, the priority setting unit 207 may set the priority of the guidance information to be higher as the distance from the host vehicle to the next right/left turning point is shorter. In this case, the display control unit 208 may switch the display area in which the first content information and the second content information are displayed on the basis of the priority set by the priority setting unit 207 at a given timing.

In addition, the vehicle display control device 20 may acquire the correspondence relationship between the type of the object and the priority and the dynamically changing priority from the outside of the host vehicle. That is, the display control unit 208 may acquire the priority set outside the host vehicle for part of or all the first content information and the second content information, and switch the display area in which the first content information and the second content information are displayed on the basis of the acquired priority.

In addition, in the above embodiment, the warning information, the guidance information, and the abnormality information have been described as examples of the second guidance information. However, the second guidance information may include information regarding seat belt wearing information of the occupant of the host vehicle, information regarding whether the door of the host vehicle is completely closed, information regarding the speed of the host vehicle, information regarding music and the like flowing in the passenger compartment of the host vehicle, or information regarding a phone call, notification of an SNS, and the like of the occupant of the host vehicle.

Moreover, remaining amount information about the first content information may be included in the second content information. In addition, in a case where the first content information indicating the content of the regulation of a certain traffic regulation mark is displayed, information indicating the content of the regulation of another traffic regulation mark may be included in the second content information.

In addition, the priority may be weighted according to the type of the traffic regulation mark. For example, in a case where the host vehicle is positioned in an area where the regulation effective ranges indicated by the plurality of types of traffic regulation marks overlap with each other, the display control unit 208 may display, in the proximal display area, the first content information and the like of the traffic regulation mark, for which higher weighting is set, and may display, in the distal display area, the first content information and the like of other traffic regulation marks. At this time, the weighting and display control related to the setting of the priority may be set on the basis of the information transmitted from the server 8 to the host vehicle. For example, the information transmitted from the server 8 is a driver model generated on the basis of the travel history of the driver of the host vehicle, and the vehicle display control device 20 may weight the setting of the priority based on the driver model. In this case, the vehicle display control device 20 can perform display control more suitable for the driver of the host vehicle based on the driving tendency of the driver of the host vehicle. Specifically, in a case where the driver of the host vehicle has a strong tendency to exceed the speed limit, the vehicle display control device 20 sets the weighting of the priority setting for the road sign of the speed limit to be high based on the driver model indicating this tendency. As a result, the display control based on the high priority is performed for the display of the first content information and the like, and the excess of the speed limit by the driver can be suppressed, that is, the display control suitable for the driver can be performed.

Note that the driver model referred to herein is not limited to a model for an individual driver or a single host vehicle, and may be a model obtained by modeling a behavior pattern and the like of a group of a plurality of people or a large number of vehicles.

As another example, the information transmitted from the server 8 is data of a traffic violation or a traffic accident in the past on the route on which the host vehicle is traveling. In this case, the vehicle display control device 20 may perform weighting regarding the setting of the priority on the basis of the data. As a result, for example, the weighting of the setting of the priority for the traffic regulation mark strongly related to the cause of the traffic violation or the traffic accident can be set high, and the traffic violation and the traffic accident can be suppressed.

As still another example, the information transmitted from the server 8 is information of display control in another vehicle traveling on the route on which the host vehicle is traveling. In this case, the vehicle display control device 20 may execute display control of the first content information and the like on the basis of the information of the display control. With this configuration, it is possible to perform display control such as erasing the display of the unnecessary first content information and the like without the driver of the host vehicle performing input and the like via the operation device 21.

In addition, in the embodiment described above, the plurality of display areas for displaying the first content information, the remaining amount information, and the second content information is display areas of virtual images respectively corresponding to the plurality of projection areas of the HUD 220. However, the present disclosure is not necessarily limited to the embodiment. For example, the plurality of display areas in which the first content information, the remaining amount information, and the second content information are displayed may be the display area of the HUD 220 and the display area of the display device 22 of a type other than the HUD 220. The display device 22 used as the display device 22 of a type other than the HUD 220 is preferably the combination meter, the CID, and the like described above in a manner that the movement of the line of sight of the driver can be suppressed to be small.

For example, the display area of the HUD 220 may be used as the distal display area Dis of the above embodiment, and the display area of the combination meter or the CID may be used as the proximal display area Pro. Note that a combination meter or a

CID display area may be used as the distal display area Dis, and a display area that is not used as the distal display area Dis among the display areas of the combination meter and the CID may be used as the proximal display area Pro. In this case, it is preferable that the display area of the CID and the display area of the combination meter are arranged in the up-down direction from the viewpoint of suppressing the movement of the line of sight of the driver.

In addition, in the above embodiment, an example in which there are two display areas in which the first content information, the remaining amount information, and the second content information can be displayed has been described, but the present invention is not necessarily limited to this. For example, there may be three or more display areas in which the first content information, the remaining amount information, and the second content information can be displayed. Also in this case, after the first content information and the remaining amount information are displayed in the display area displaying the image seen more distally from the driver seated on the driver's seat among the plurality of display areas, the display area displaying the first content information and the remaining amount information may be switched to the display area displaying the image seen more proximally from the driver seated on the driver's seat. In addition, the display area in which the information is to be displayed may be switched according to the priority of each piece of the information, in a case where the first content information and the second content information are to be displayed in the same display area, in a case where a plurality of pieces of the first content information is to be displayed in the same display area, or in a case where a plurality of pieces of the second content information is to be displayed in the same display area.

FIG. 32 is a hardware configuration diagram illustrating an example of the vehicle display control device 20 according to the present embodiment.

The vehicle display control device 20 of the above embodiment includes a control device such as a CPU 36, a storage device such as a ROM 38, a RAM 40, and an HDD 42, an I/F unit 32 which is an interface with various devices, an output unit 30 which outputs various types of information such as output information, an input unit 34 which receives an operation by a driver, and a bus 46 which connects the respective units, and has a hardware configuration using a normal computer.

A computer program for executing each of the above processing executed by the 5 vehicle display control device 20 according to each embodiment described above is provided by being recorded in a computer-readable recording medium such as a CD-ROM, a flexible disk (FD), a CD-R, or a digital versatile disk (DVD) as a file in an installable format or an executable format.

In addition, the program for executing each of the above processing executed by the 10 vehicle display control device 20 according to the above embodiment may be stored on a computer connected to a network such as the Internet and provided by being downloaded via the network. In addition, a program for executing each of the above processing executed by the vehicle display control device 20 according to the above embodiment may be provided or distributed via a network such as the Internet. 15 In addition, the program for executing each of the above processing executed by the vehicle display control device 20 according to the above embodiment may be provided by being incorporated in advance in the ROM 38 and the like, or may be stored in the HDD 42.

Although some embodiments of the present disclosure have been described, these embodiments have been presented as examples, and are not intended to limit the scope of the invention. These embodiments can be implemented in various other forms, and various omissions, replacements, and changes can be made without departing from the gist of the invention. These embodiments and modifications are included in the scope and gist of the invention, as well as in the scope of the invention described in the claims and the equivalent scope.

### Supplement

As is apparent from the above embodiments, the present disclosure includes the following aspects. In the following, reference numerals are given in parentheses only to clearly indicate the correspondence relationship with the embodiments.

A vehicle display control device (20) according to a first aspect is provided in a vehicle. The vehicle display control device (20) includes a recognition unit (203) and a display control unit (208). The recognition unit (203) recognizes a traffic regulation mark indicating a traffic regulation provided on a traveling route of the vehicle. The display control unit (208) controls a display device (22) to display, in a display area in front of a driver's seat of the vehicle, first content information indicating content of a regulation in an effective range indicated by the traffic regulation mark in a case where the vehicle enters the effective range of the regulation, and second content information indicating content other than the first content information. The display control unit (208) controls display of the first content information and the second content information in the display area on the basis of priorities set for the first content information and the second content information. According to the first aspect, a plurality of pieces of information can be appropriately displayed on the display device (22) in a case where, for example, the first content information and the second content information are to be displayed. Therefore, even in a case where a plurality of pieces of information is displayed, it is easy for the driver to recognize the content of the information.

A vehicle display control device (20) according to a second aspect can be implemented by a combination with the first aspect. In the second aspect, the vehicle display control device (20) further includes a priority setting unit (207). The priority setting unit (207) sets priorities of the first content information and the second content information. The display control unit (208) controls display of the first content information and the second content information in the display area on the basis of the priorities set for the first content information and the second content information by the priority setting unit (207). According to the second aspect, the first content information and the second content information can be displayed on the basis of the priority set by the priority setting unit (207). Therefore, the driver can easily recognize the first content information and the second content information.

A vehicle display control device (20) according to a third aspect can be implemented by a combination with the first aspect or the second aspect. In the third aspect, the second content information includes at least one of warning information for giving a warning about an object positioned around the vehicle, guidance information for giving a guide to a route to a destination, and abnormality information indicating that an abnormality has occurred in the vehicle. According to the third aspect, display of the first content information, the warning information, the guidance information, and the abnormality information can be controlled on the basis of the set priorities. Therefore, the driver can easily recognize the first content information and the second content information that can include the warning information, the guidance information, and the abnormality information.

A vehicle display control device (20) according to a fourth aspect can be implemented by a combination with the third aspect. In the fourth aspect, the second content information includes at least one of the warning information and the abnormality information. The priority is set higher for the warning information and the abnormality information than for the first content information. According to the fourth aspect, the first content information and the second content information can be displayed on the basis of the priority set higher than the first content information with respect to the warning information and the abnormality information. Therefore, the driver can more easily recognize the warning information and the abnormality information.

A vehicle display control device (20) according to a fifth aspect can be implemented by a combination with the third aspect or the fourth aspect. In the fifth aspect, the second content information includes the warning information and the guidance information. The priority is set higher for the warning information than for the guidance information. According to the fifth aspect, the second content information can be displayed on the basis of the priority set higher than the guidance information with respect to the warning information. Therefore, the driver can more easily recognize the warning information.

A vehicle display control device (20) according to a sixth aspect can be implemented by a combination with any one of the first to fifth aspects. In the sixth aspect, the display area is a plurality of display areas having different positions. In a case where the display areas for displaying the first content information and the second content information are a same display area, the display control unit (208) changes a display mode of information having a lower priority set among the first content information and the second content information. According to the sixth aspect, even in a case where the display areas for displaying the first content information and the second content information overlap with each other, the first content information and the second content information can be displayed in a manner that the information having a higher priority is more appropriately recognized. Therefore, the driver can more easily recognize the information having a higher priority.

A vehicle display control device (20) according to a seventh aspect can be implemented by a combination with the sixth aspect. In the seventh aspect, the display area includes a distal display area and a proximal display area having a position different from the distal display area and displays an image that appears more proximal to a user than the distal display area. According to the seventh aspect, the display area for displaying the first content information and the second content information can be switched between the distal display area and the proximal display area on the basis of the priority. Therefore, the driver can more easily recognize the information having a higher priority.

A vehicle display control device (20) according to an eighth aspect can be implemented by a combination with the seventh aspect. In the eighth aspect, the display control unit (208) switches the display area for displaying the first content information to the proximal display area in a case where information having a higher priority than the first content information among the second content information is displayed in the distal display area and in a case where the display area for displaying the first content information is the distal display area. According to the eighth aspect, the second content information having a higher priority can be preferentially displayed in the distal display area. Therefore, the driver can more easily recognize the information having a higher priority.

A vehicle display control device (20) according to a ninth aspect can be implemented by a combination with the seventh aspect. In the ninth aspect, the display control unit (208) reduces a size for displaying the first content information in a case where information having a higher priority than the first content information among the second content information is displayed in the distal display area and in a case where the display area for displaying the first content information is the distal display area. According to the ninth aspect, the second content information having a higher priority can be preferentially displayed in the distal display area. Therefore, the driver can more easily recognize the information having a higher priority.

A vehicle display control device (20) according to a 10th aspect can be implemented by a combination with any one of the seventh to ninth aspects. In the 10th aspect, the display control unit (208) switches the display area for displaying the first content information to the distal display area in a case where the information having the priority set higher than the first content information among the second content information is displayed in the proximal display area and in a case where the display area for displaying the first content information is the proximal display area. According to the 10th aspect, the second content information having a higher priority can be preferentially displayed in the proximal display area. Therefore, the driver can more easily recognize the information having a higher priority.

A vehicle display control device (20) according to an 11th aspect can be implemented by a combination with any one of the seventh to ninth aspects. In the 11th aspect, the display control unit (208) switches the display area for displaying the first content information to the distal display area and reduces a size for displaying the first content information in a case where the information having the priority set higher than the first content information among the second content information is displayed in the proximal display area and in a case where the display area for displaying the first content information is the proximal display area. According to the 11th aspect, the second content information having a higher priority can be preferentially displayed in the proximal display area. Therefore, the driver can more easily recognize the information having a higher priority.

A vehicle display control device (20) according to a 12th aspect can be implemented by a combination with any one of the seventh to ninth aspects. In the 12th aspect, in a case where the information having the priority set higher than predetermined information included in the first content information among the second content information is displayed in the proximal display area, and in a case where the display area for displaying the predetermined information is the proximal display area and low priority information having the priority set lower than the predetermined information is displayed in the distal display area, display of the low priority information is stopped and the display area for displaying the predetermined information is switched to the distal display area. According to the 12th aspect, the second content information having a higher priority can be preferentially displayed in the proximal display area. Therefore, the driver can more easily recognize the information having a higher priority.

A vehicle display control device (20) according to a 13th aspect can be implemented by a combination with any one of the seventh to 12th aspects. In the 13th aspect, the display area for displaying the first content information is switched to the proximal display area in a case where the first content information is displayed in the distal display area and in a case where a display area for displaying the information having the priority set higher than the first content information among the second content information is the distal display area. According to the 13th aspect, the second content information having a higher priority can be preferentially displayed in the distal display area. Therefore, the driver can more easily recognize the information having a higher priority.

A vehicle display control device (20) according to a 14th aspect can be implemented by a combination with any one of the seventh to 12th aspects. In the 14th aspect, a size for displaying the first content information is reduced in a case where the first content information is displayed in the distal display area and in a case where a display area for displaying the information having the priority set higher than the first content information among the second content information is the distal display area. According to the 14th aspect, the second content information having a higher priority can be preferentially displayed in the distal display area. Therefore, the driver can more easily recognize the information having a higher priority.

A vehicle display control device (20) according to a 15th aspect can be implemented by a combination with any one of the seventh to 12th aspects. In the 15th aspect, display of the first content information is stopped in a case where the first content information is displayed in the distal display area and in a case where a display area for displaying the information having the priority set higher than the first content information among the second content information is the distal display area. According to the 15th aspect, the second content information having a higher priority can be preferentially displayed in the distal display area. Therefore, the driver can more easily recognize the information having a higher priority.

A vehicle display control device (20) according to a 16th aspect can be implemented by a combination with any one of the seventh to 15th aspects. In the 16th aspect, the display area for displaying the first content information is switched to the distal display area in a case where the first content information is displayed in the proximal display area and in a case where a display area for displaying the information having the priority set higher than the first content information among the second content information is the proximal display area. According to the 16th aspect, the second content information having a higher priority can be preferentially displayed in the proximal display area. Therefore, the driver can more easily recognize the information having a higher priority.

A vehicle display control device (20) according to a 17th aspect can be implemented by a combination with any one of the seventh to 15th aspects. In the 17th aspect, the display area for displaying the first content information is switched to the distal display area and a size for displaying the first content information is reduced in a case where the first content information is displayed in the proximal display area and in a case where a display area for displaying the information having the priority set higher than the first content information among the second content information is the proximal display area. According to the 17th aspect, the second content information having a higher priority can be preferentially displayed in the proximal display area. Therefore, the driver can more easily recognize the information having a higher priority.

A vehicle display control device (20) according to an 18th aspect can be implemented by a combination with any one of the seventh to 15th aspects. In the 18th aspect, in a case where the predetermined information included in the first content information is displayed in the proximal display area, and in a case where the display area for displaying information having a higher priority than the predetermined information among the second content information is the proximal display area and the low priority information having the priority set lower than the predetermined information is displayed in the distal display area, display of the low priority information is stopped and the display area for displaying the predetermined information is switched to the distal display area. According to the 18th aspect, the second content information having a higher priority can be preferentially displayed in the proximal display area. Therefore, the driver can more easily recognize the information having a higher priority.

A display device (22) according to a 19th aspect includes the vehicle display control device (20) according to any one first to 18th aspects, a display (221), and a projection unit (222). The display (221) forms a display image in accordance with an instruction from the vehicle display control device (20). The projection unit (222) projects the display image displayed by the display (221) onto a projection member (10). According to the 19th aspect, a plurality of pieces of information can be appropriately displayed on the display device (22), such as in a case where the first content information and the second content information are displayed. Therefore, even in a case where a plurality of pieces of information is displayed, it is easy for the driver to recognize the content of the information.

A vehicle display control method according to a 20th aspect controls a display device (22) provided in a vehicle. The vehicle display control method includes a recognition step and a display control step. The recognition step recognizes a traffic regulation mark indicating a traffic regulation provided on a traveling route of the vehicle. The display control step controls a display device (22) to display, in a display area in front of a driver's seat of the vehicle, first content information indicating content of a regulation in an effective range indicated by the traffic regulation mark in a case where the vehicle enters the effective range of the regulation, and second content information indicating content other than the first content information. The display control step controls display of the first content information and the second content information in the display area on the basis of priorities set for the first content information and the second content information. According to the 20th aspect, a plurality of pieces of information can be appropriately displayed on the display device (22), such as in a case where the first content information and the second content information are displayed. Therefore, even in a case where a plurality of pieces of information is displayed, it is easy for the driver to recognize the content of the information.

According to the present disclosure, a plurality of pieces of information can be appropriately displayed on a display device.

What is claimed is:

1. A vehicle display control device provided in a vehicle, the vehicle display control device comprising
processing circuitry connected to a memory and configured to:
recognize a traffic regulation mark indicating a traffic regulation provided on a traveling route of the vehicle;
control a display device to display first content information and second content information in a display area in front of a driver's seat of the vehicle, the first content information indicating content of a regulation in an effective range indicated by the traffic regulation mark in a case where the vehicle enters the effective range of the regulation, the second content information indicating content other than the first content information; and
control display of the first content information and the second content information in the display area on the basis of priorities set for the first content information and the second content information.

2. The vehicle display control device according to claim 1, wherein the processing circuitry is configured to:
set the priorities of the first content information and the second content information.

3. The vehicle display control device according to claim 1, wherein the second content information includes at least one of
warning information for giving a warning about an object positioned around the vehicle,
guidance information for giving a guide to a route to a destination, and
abnormality information indicating that an abnormality has occurred in the vehicle.

4. The vehicle display control device according to claim 3, wherein
the second content information includes at least one of the warning information and the abnormality information, and
the warning information and the abnormality information are each given a higher priority than the first content information.

5. The vehicle display control device according to claim 3, wherein
the second content information includes the warning information and the guidance information, and
the warning information is given a higher priority than the guidance information.

6. The vehicle display control device according to claim 1, wherein
the display area includes a plurality of display areas of different positions, and
the processing circuitry is configured, in a case where the display areas for displaying the first content information and the second content information are the same, to change a display mode of one of the first content information and the second content information, the one being given a lower priority than the other.

7. The vehicle display control device according to claim 6, wherein the display area includes a distal display area and a proximal display area whose position is different from the distal display area, the proximal display area displaying an image appearing more proximal to a user than the distal display area.

8. The vehicle display control device according to claim 7, wherein the processing circuitry is configured to switch a display area for displaying the first content information to the proximal display area in a case where
information included in the second content information is displayed in the distal display area, the included information being given a higher priority than the first content information, and
the display area for displaying the first content information is the distal display area.

9. The vehicle display control device according to claim 7, wherein the processing circuitry is configured to reduce a size for displaying the first content information in a case where
information included in the second content information is displayed in the distal display area, the included information being given a higher priority than the first content information, and
the display area for displaying the first content information is the distal display area.

10. The vehicle display control device according to claim 7, wherein the processing circuitry is configured to switch a display area for displaying the first content information to the distal display area in a case where
information included in the second content information is displayed in the proximal display area, the included information being given a higher priority than the first content information, and
the display area for displaying the first content information is the proximal display area.

11. The vehicle display control device according to claim 7, wherein the processing circuitry is configured to switch a display area for displaying the first content information to the distal display area and reduce a size for displaying the first content information in a case where
information included in the second content information is displayed in the proximal display area, the included information being given a higher priority than the first content information, and
the display area for displaying the first content information is the proximal display area.

12. The vehicle display control device according to claim 7, wherein the processing circuitry is configured to stop display of low priority information and switch a display area for displaying predetermined information included in the first content information to the distal display area, the low priority information being given a lower priority than the predetermined information, the stop of display and the switch of a display area being performed in a case where
information included in the second content information is displayed in the proximal display area, the included information being given a higher priority than the predetermined information,
the display area for displaying the predetermined information is the proximal display area, and
the low priority information is displayed in the distal display area.

13. The vehicle display control device according to claim 7, wherein the processing circuitry is configured to switch a display area for displaying the first content information to the proximal display area in a case where
the first content information is displayed in the distal display area, and
a display area for displaying information included in the second content information is the distal display area, the included information being given a higher priority than the first content information.

14. The vehicle display control device according to claim 7, wherein the processing circuitry is configured to reduce a size for displaying the first content information in a case where
the first content information is displayed in the distal display area, and
a display area for displaying information included in the second content information is the distal display area, the included information being given a higher priority than the first content information.

15. The vehicle display control device according to claim 7, wherein the processing circuitry is configured to stop display of the first content information in a case where
the first content information is displayed in the distal display area, and
a display area for displaying information included in the second content information is the distal display area, the included information being given a higher priority than the first content information.

16. The vehicle display control device according to claim 7, wherein the processing circuitry is configured to switch a display area for displaying the first content information to the distal display area in a case where
the first content information is displayed in the proximal display area, and
a display area for displaying information included in the second content information is the proximal display area, the included information being given a higher priority than the first content information.

17. The vehicle display control device according to claim 7, wherein the processing circuitry is configured to switch a display area for displaying the first content information to the distal display area and reduce a size for displaying the first content information in a case where
the first content information is displayed in the proximal display area, and
a display area for displaying information included in the second content information is the proximal display area, the included information being given a higher priority than the first content information.

18. The vehicle display control device according to claim 7, wherein the processing circuitry is configured to stop display of low priority information and switch a display area for displaying predetermined information included in the first content information to the distal display area, the low priority information being given a lower priority than the predetermined information, the stop of display and the switch of a display area being performed in a case where
the predetermined information is displayed in the proximal display area,
a display area for displaying information included in the second content information is the proximal display area, the included information being given a higher priority than the predetermined information, and
the low priority information is displayed in the distal display area.

19. A display device comprising:
a display configured to form a display image in accordance with an instruction from the vehicle display control device according to claims 1; and
an optical system configured to project the display image formed by the display onto a projection member.

20. A vehicle display control method for controlling a display device provided in a vehicle, the vehicle display control method comprising:
recognizing a traffic regulation mark indicating a traffic regulation provided on a traveling route of the vehicle;
controlling the display device to display first content information and second content information in a display area in front of a driver's seat of the vehicle, the first content information indicating content of a regulation in an effective range indicated by the traffic regulation mark in a case where the vehicle enters the effective range of the regulation, the second content information indicating content other than the first content information; and
controlling display of the first content information and the second content information in the display area on the basis of priorities set for the first content information and the second content information.
